(19) United States
(12) Patent Application Publication
(10) Pub. No.: US 2025/0369340 A1
(43) Pub. Date: Dec. 4, 2025

(54) METHOD OF MEASURING A PROFILE OF A WELLBORE AND WELLBORE MEASURING APPARATUS THEREFOR

(71) Applicant: Geonomic Technologies Inc., Calgary (CA)

(72) Inventors: Christopher S. THOMPSON, Calgary (CA); David A. SWITZER, Conroe, TX (US); Eric A. JANSEN, Calgary (CA); Kyle W. TWYNAM, Calgary (CA); Jawad A. ALSADAH, Katy, TX (US)

(73) Assignee: Geonomic Technologies Inc., Calgary (CA)

(21) Appl. No.: 19/246,967

(22) Filed: Jun. 24, 2025

Related U.S. Application Data
(63) Continuation of application No. PCT/CA2024/050043, filed on Jan. 16, 2024.
(60) Provisional application No. 63/480,654, filed on Jan. 19, 2023.

(51) Int. Cl. E21B 47/017; E21B 47/07; E21B 49/00; G01V 11/00

(52) U.S. Cl. CPC E21B 47/017; E21B 47/07; E21B 49/00; G01V 11/002; E21B 2200/20

(57) ABSTRACT

There is provided a wellbore measuring apparatus including an outer body that is tubular and connectable in line with a drill string. The wellbore measuring apparatus includes a plurality of sensors operatively connected to the outer body. The plurality of sensors are arranged to measure at least one characteristic of a wellbore. The plurality of sensors are positioned in a double helix arrangement according to one aspect. The wellbore measuring apparatus includes according to another aspect, an inner passageway positioned between spaced-apart ends of the outer body and which is helical in shape. The wellbore measuring apparatus includes according to a further aspect, a housing within which the sensors are received, with the housing enabling drill fluid to pass therethrough and with the housing being longitudinally twisted in shape.

### BACKGROUND OF THE INVENTION

### Field of the Invention

The present invention relates generally to measuring wellbores and in particular to an apparatus and methods for engaging measuring sensors with a wellbore from an in-line tool within a drill string.

### Description of the Related Art

In oilfield applications, tubular wells (boreholes or wellbores) are directionally drilled through the earth using a drilling string suspended from a drilling rig. A drilling string is a collection of assembled parts including drill pipes, drill collars, tools and the drill bit. The parts are threadably coupled together to form the drill string, with the drill bit on the distal end of the string. The drilling rig may include equipment to rotate the drilling string, or the drilling string may include a mud motor, which uses hydraulic energy from drilling fluid to turn the drill bit, independent of the drill string. The drilling fluid, also known as drilling mud, passes through the interior of the drilling string, exiting the string at the drill bit and is subsequently pumped back to the surface around the exterior of the drilling string, carrying the drill cuttings with it for treatment and disposal.

It is desirable and common practice to measure the physical properties of the wellbore during or following drilling operations. Information may be obtained about the well path and position, depth, bottom-hole location, geophysical properties of the rock, etc. This information can be used to optimize the efficiency of the wellbore placement and provide information for future well use as well as any remedial steps which must be performed on the wellbore.

Measurement while drilling (MWD) components may include a variety of sensors which allow for continued drilling operation while collecting data with the sensors. It should be noted that in the art it is known to distinguish between the terms “measurement while drilling” (MWD) and “logging while drilling” (LWD) in that the MWD term generally refers to measurements relating to the progress of the drilling operation (such as the trajectory, rate of penetration, etc.), whereas LWD relates to information about the wellbore physical properties (such as the porosity of the rock, vertical seismic profile, etc.). For the purpose of the description of the present invention, “wellbore measurement” is intended to cover both classifications of sensors, without limiting the type of sensors that may be described below.

One example of a method and apparatus for measuring a wellbore is described in International Patent Application Publication No. WO 2021/0179092 to Thompson et al., the disclosure of which is hereby incorporated herein by reference.

Other examples of measuring devices are described in the following patents and patent application publications: U.S. Pat. No. 4,692,908 to Ekstrom et al.; U.S. Pat. No. 6,564,883 to Fredericks et al.; United States Patent Application Publication No. 2020/0190974 to Manders; U.S. Pat. No. 10,329,856 to Prammer; United States Patent Application Publication No. 2005/0283315 A1 to Haugland; United States Patent Application Publication No. 2013/0118809 A1 to Vecningen; International Patent Application Publication No. WO 2017/069745 A1 to Cramm et al.; and International Patent Application Publication No. WO 2019/215070 A1 to Hovland et al.

### BRIEF SUMMARY OF INVENTION

There is provided, and it is an object to provide, an improved wellbore measuring apparatus disclosed herein.

There is accordingly provided a wellbore measuring apparatus according to one aspect. The wellbore measuring apparatus includes an outer body that is tubular and connectable in line with a drill string. The wellbore measuring apparatus includes a plurality of contactless sensors angularly spaced relative to the outer body and arranged in a plurality of tiers. Each said tier includes two or more said sensors. The tiers are spaced-apart axially from one another along the outer body. Each said sensor is arranged to measure at least one characteristic of a wellbore.

There is also provided a wellbore measuring apparatus according to another aspect. The wellbore measuring apparatus includes an outer body that is tubular and connectable in line with a drill string. The wellbore measuring apparatus includes a plurality of acoustic sensors angularly spaced relative to the outer body and arranged in a plurality of tiers. Each said tier includes two or more said sensors. The tiers are spaced-apart axially from one another along the outer body. Each said sensor is arranged to measure at least one characteristic of a wellbore. The sensors are positioned in a helical arrangement according another example.

There is additionally provide a wellbore measuring apparatus according to yet another aspect. The wellbore measuring apparatus includes an outer body that is tubular and connectable in line with a drill string. The wellbore measuring apparatus includes a plurality of axially spaced pairs of sensors. Each pair of sensors is angularly positioned relative to one or more adjacent said pairs of sensors. Each sensor is arranged to measure at least one characteristic of a wellbore.

There is further provided a wellbore measuring apparatus according to another aspect. The wellbore measuring apparatus includes an outer body that is tubular and connectable in line with a drill string. The outer body has a bore extending between ends thereof. The outer body has an outer surface and a plurality of apertures extending radially inwards from the outer surface thereof. The plurality of apertures are in fluid communication with the bore of the outer body and are positioned in a helical arrangement. The wellbore measuring apparatus includes a sensor assembly positioned to threadably couple to and extend within the outer body at least in part. The sensor assembly includes a plurality of sensors aligned with and positioned in communication with respective ones of said apertures of the outer body.

There is yet also provided a wellbore measuring apparatus according an additional aspect. The wellbore measuring apparatus includes an outer body that is tubular and connectable in line with a drill string. The outer body has a plurality of apertures extending radially inwards therein. The wellbore measuring apparatus includes a plurality of sensors, each aligning with a corresponding said aperture. Each sensor is arranged to measure at least one characteristic of a wellbore. The wellbore measuring apparatus includes a plurality of windows, each covering a respective said aperture.

There is yet also provided a wellbore measuring apparatus according to a further aspect. The wellbore measuring apparatus includes an outer body that is tubular and connectable in line with a drill string. The outer body has a plurality of apertures extending radially inwards therein. The wellbore measuring apparatus includes a plurality of sensors. Each sensor aligns with a corresponding said aperture and is encased. Each sensor is arranged to measure at least one characteristic of a wellbore.

There is further provided a wellbore measuring apparatus according to yet another aspect. The wellbore measuring apparatus includes an outer body that is tubular and connectable in line with a drill string. The wellbore measuring apparatus includes at least one helical elongate member coupled to and extending radially outwards from the outer body. The wellbore measuring apparatus includes a plurality of sensors extending adjacent and radially inwardly positioned relative to said at least one helical elongate member. Each sensor is arranged to measure at least one characteristic of a wellbore.

There is also provided a wellbore measuring apparatus according to an additional aspect. The wellbore measuring apparatus includes an outer body that is tubular and connectable in line with a drill string. The wellbore measuring apparatus includes two or more angularly spaced-apart helical elongate members coupled to and extending radially outwards from the outer body. The wellbore measuring apparatus includes a plurality of sensors positioned between and extending along said helical elongate members. Each sensor is arranged to measure at least one characteristic of a wellbore.

There is additionally provided a wellbore measuring apparatus according to a further aspect and comprising an in-line bottom hole assembly for data logging while tripping. The in-line bottom hole assembly includes an internal spiral sensor assembly that is a helical shape with two sets of sensors offset 180 degrees from each other and arranged in spirals. The in-line bottom hole assembly includes an outer body coupled to and removable from the internal spiral sensor assembly.

There is further provided a wellbore measuring apparatus according to a further aspect. The wellbore measuring apparatus includes a logging-while-tripping (LWT) bottom hole assembly. The LWT bottom hole assembly remains part of a drilling assembly. The LWT bottom hole assembly is only activated to log a wellbore during static (non-drilling) conditions and procedures. Wellbore measuring apparatus is configured to be robust and may thus function as a delivery system for the sensors to perform logging measurements during static wellbore conditions.

There is additionally provided a wellbore measuring apparatus according to yet another aspect. The wellbore measuring apparatus includes a logging-while-tripping (LWT) bottom hole assembly. The LWT bottom hole assembly includes an outer body that is tubular and connectable connection in line with a drill string. The LWT bottom hole assembly has a passageway extending through the outer body between the ends of the outer body. The LWT bottom hole assembly includes a plurality of sensors arranged to measure at least one characteristic of a wellbore. The LWT bottom hole assembly includes a processor configured to receive output signals from the sensors. The processor is configured to log the output signals during static or non-drilling conditions.

There is also provided a wellbore measuring apparatus according to yet an additional aspect. The wellbore measuring apparatus includes a first logging-while-tripping unit. The first LWT unit is configured to log wellbore data to one or more characteristics of a wellbore. The wellbore measuring apparatus includes a second logging-while-tripping (LWT) unit. The second LWT unit is configured to also log wellbore data to one or more characteristics of a wellbore. The first LWT unit couples to and is integrated with the second LWT unit. At least some of the sensors are acoustic sensors and at least some of the sensors function in conjunction with abutting members which selectively abut the outer surface of the wellbore according to one non-limiting embodiment.

The one or more characteristics of the wellbore as determined via the output signals of the acoustic sensors are compared to the one or more characteristics of the wellbore as determined via the output signals of the sensors which function in conjunction with abutting members. An indication of the accuracy of the one or more characteristics of the wellbore so determined is obtained thereby. If the difference in the one or more characteristics of the wellbore so determined is above a predetermined threshold, the processor determines that calibration of one or more of the sensors is required.

There is also provided a method of measuring at least one characteristic of a wellbore according to one aspect. The method includes removably coupling a tubular body in line with a drill string. The method includes positioning a plurality of longitudinally-spaced contactless sensors in a helical pattern relative to the outer body and arranged in a plurality of tiers, with each said tier comprising two or more said sensors and the tiers being spaced-apart axially from one another along the outer body. The method includes measuring the at least one characteristic of the wellbore via the sensors.

There is further provided a method of measuring at least one characteristic of a wellbore according to another aspect. The method includes removably coupling a tubular body in line with a drill string. The method includes forming a plurality of longitudinally-spaced and helically-arranged apertures into an outer surface of the tubular body. The method includes positioning a plurality of sensors in fluid communication with respective ones of the apertures. The method includes measuring the at least one characteristic of the wellbore via the sensors.

There is also provided a method of measuring at least one characteristic of a wellbore according to yet another aspect. The method includes removably coupling a tubular body in line with a drill string. The method includes forming a plurality of longitudinally-spaced and helically-arranged apertures into an outer surface of the tubular body. The method includes positioning a plurality of sensors in fluid communication with respective ones of the apertures. The method includes measuring radii, pressure and thermal properties of the wellbore via the sensors while tripping out of the wellbore to the surface.

There is additional provided a method of determining a profile and/or at least one characteristic of a wellbore according to one aspect. The method includes logging-while-tripping via a first logging-while-tripping (LWT) unit configured to log wellbore data to one or more characteristics of the wellbore. The method includes logging-while-tripping via a second logging-while-tripping (LWT) unit configured to log wellbore data to said one or more characteristics of the wellbore. The method includes determining the profile of the wellbore taking into account data of outputted from both the first LWT unit and the second LWT unit.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention:

FIG. 1 is a cross sectional view of a wellbore together with a drilling string therein which includes a wellbore measuring apparatus according to one aspect;

FIG. 2 is a right side elevation view of the apparatus of FIG. 1;

FIG. 3 is a rear elevation view thereof;

FIG. 4 is a left side elevation view thereof;

FIG. 5 is a front elevation view thereof;

FIG. 6 is an exploded, front, right side perspective view of the apparatus thereof, with the apparatus including an outer subassembly and an inner subassembly;

FIG. 7 is an exploded, front, right side perspective view of the inner subassembly of the apparatus of FIG. 6, the inner subassembly of the apparatus including a sensor housing;

FIG. 8 is a front elevation view of the sensor housing of the inner subassembly of the apparatus of FIG. 7;

FIG. 9 is a sectional view taken along lines 9-9 of the sensor housing of the inner subassembly of the apparatus of FIG. 8;

FIG. 10 is a front, right side perspective view of the sensor housing of the inner subassembly of the apparatus of FIG. 9, with an outer portion of the sensor housing removed and not shown;

FIG. 11 is a front, right side perspective view of a sensor assembly of the inner subassembly of the apparatus of FIG. 7, with the sensor assembly including a plurality of sensors together with a wiring pathway via which wiring of the sensor assembly is routed;

FIG. 12 is a sectional view taken along lines 12-12 of the apparatus of FIG. 5;

FIG. 13 is a sectional view taken along lines 13-13 of the apparatus of FIG. 5;

FIG. 14 is a sectional view taken along lines 14-14 of the apparatus of FIG. 5;

FIG. 15 is a sectional view taken along lines 15-15 of the apparatus of FIG. 5;

FIG. 16 is a flowchart of an operation of the apparatus of FIG. 2 according to one aspect;

FIG. 17 is a flowchart of an operation of the apparatus of FIG. 2 according to another aspect;

FIG. 18 is a graphical display showing an example of a three-dimensional (3D) representation of a borehole section of the wellbore of FIG. 1 as obtained via the wellbore measuring apparatus of FIG. 1;

FIG. 19 is a graphical display of a lateral cross-section of the 3D representation of the borehole section of the wellbore of FIG. 18; and

FIG. 20 is a cross sectional view of a wellbore together with a drilling string therein which includes a wellbore measuring apparatus according to another aspect.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

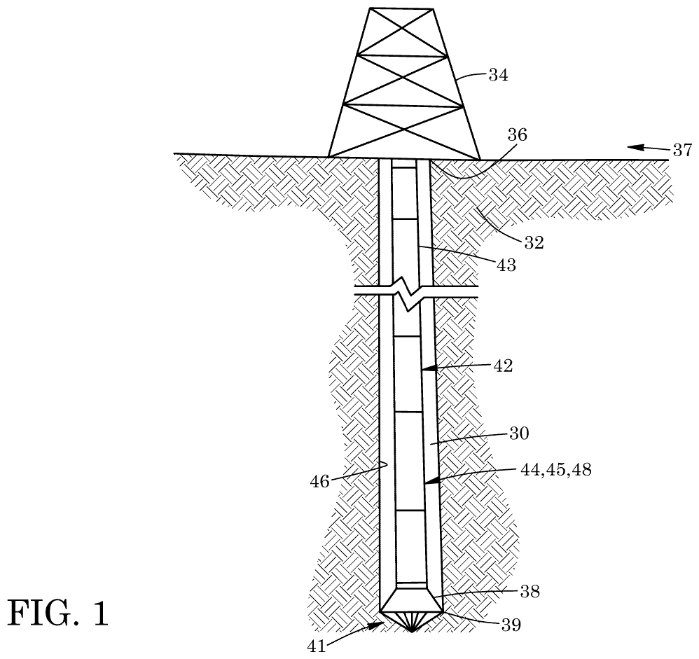

Referring to the drawings and first to FIG. 1, there is shown a wellbore 30 is drilled into the ground 32 by known methods. The wellbore may be referred to as a drill bore. The production zone may contain a horizontally extending hydrocarbon bearing rock formation or may span a plurality of hydrocarbon bearing rock formations such that the wellbore has a path designed to cross or intersect each formation. Wellbore 30 includes a drilling rig 34 at a top end 36 thereof and a drilling or bottom hole assembly 38 at a distal end 39 of a drill string 42 extending therebetween. The top end of the wellbore is at surface 37. Drill string 42 includes a drill pipe 43 in this example as well as other components which may be known per to those skilled in the art.

A wellbore measuring apparatus 44 is located within or in line with the drill string. The wellbore measuring apparatus may be referred to as a wellbore measuring tool or downhole tool. Wellbore measuring apparatus 44 is configured for measuring one or more properties and/or characteristics of wellbore 30, such as wellbore wall 46 as will be further described below. The wellbore wall may be referred to as the inner wall of wellbore 30.

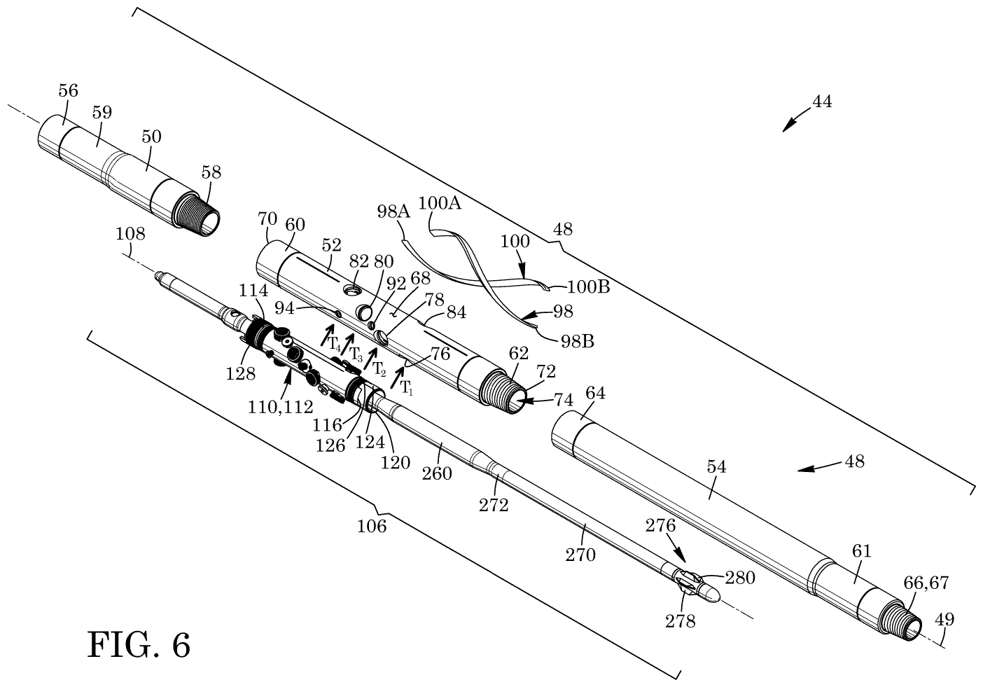

As seen in FIG. 6, wellbore measuring apparatus 44 includes an outer subassembly 48. The outer subassembly is elongate and extends along a longitudinal axis 49. Outer subassembly 48 includes at least one and in this example a plurality of elongate conduits in this example: a first or proximal conduit, in this non-limiting example in the form of an uphole crossover 50; a second or middle conduit, in this non-limiting embodiment an outer body 52; and a third or distal conduit, in this non-limiting embodiment a downhole crossover 54.

The uphole crossover in this example may be referred to as an uphole crossover subassembly. Uphole crossover 50 has a first threaded end portion, in this example a female threaded end portion 56 for threaded connection in line to drill pipe 43 or other components of drill string 42 seen in FIG. 1. Referring back to FIG. 6, the uphole crossover has a second threaded end portion, in this example a male threaded end portion 58 spaced-apart from the female threaded end portion thereof.

Still referring to FIG. 6, outer body 52 has a first threaded end portion, in this example a female threaded end portion 60 and a second threaded end portion, in this example a male threaded end portion 62 spaced-apart from the first female threaded end portion thereof. Crossover 50 and outer body 52 are selectively connectable together in line as well as selectively removable from each other via threaded end portions 58 and 60 thereof.

Downhole crossover 54 in this example may be referred to as a downhole crossover subassembly. The downhole crossover has a first threaded end portion, in this example a female threaded end portion 64 and a second threaded end portion, in this example a male threaded end portion 66 spaced-apart from the first female threaded end portion thereof. Outer body 52 and downhole crossover 54 are selectively connectable together in line as well as selectively removable from each other via threaded end portions 62 and 64 thereof. Threaded end portion 66 of the downhole crossover is selectively connectable in line to bottom hole assembly 38 seen in FIG. 1 or other components of drill string 42 such as drill pipe or the like. In the case of the former, wellbore measuring apparatus 44 may thus be referred to as part of the bottom hole assembly in one non-limiting embodiment, though this is not strictly required. In addition or alternatively, threaded end portion 66 of downhole crossover 54 seen in FIG. 6 may be referred to as a downhole end 67 of the downhole crossover with a connection that enables connection to standard drill pipe. Crossovers 50 and 54 and outer body 52 of outer subassembly 48 are thus individually and collectively selectively connectable to and removable from drill string 42 seen in FIG. 1.

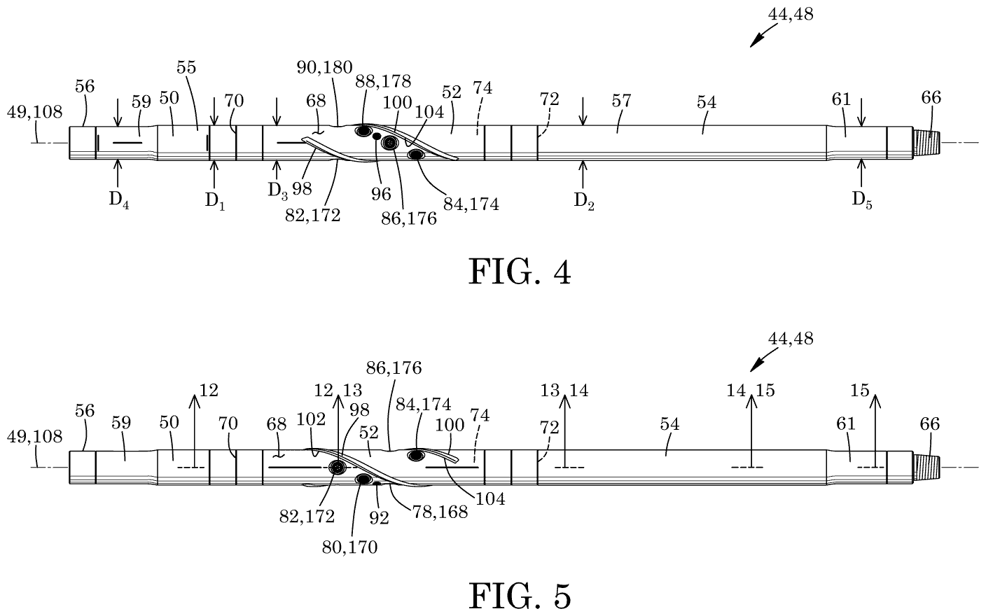

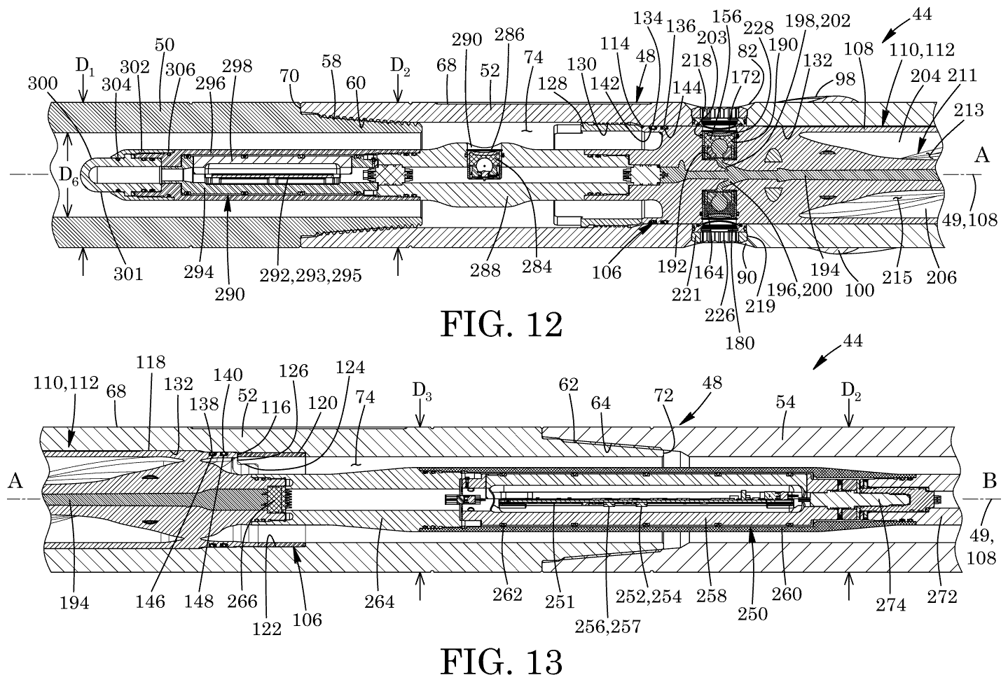

Referring back to FIG. 6, the crossovers may thus be said to have spaced-apart ends or end portions 56 and 66 for threaded connection in line with drill string 42 and/or components thereof seen in FIG. 1. As seen in FIG. 4, crossovers 50 and 54 include first or inner longitudinal portions 55 and 57 which couple to outer body 52. The longitudinal portions have outer diameters D₁ and D₂ substantially equal to outer diameter D₃ of the outer body in this non-limiting embodiment, thereby forming a streamline shape. Still referring to FIG. 4, crossovers 50 and 54 include second or outer longitudinal portions 59 and 61 which couple to longitudinal portions 55 and 57, respectively, and which are longitudinally spaced from outer body 52. Longitudinal portions 59 and 61 couple to other drill string components and have diameters D₄ and D₅ corresponding to said other drill string components in this non-limiting example. Diameters D₄ and D₅ are different from and in this example less than diameters D₁ and D₂. Crossovers 50 and 54 have inner diameters D₆ and D₇ seen in FIGS. 12 and 15 and which remain the same throughout this transition in outer diameters in this non-limiting embodiment.

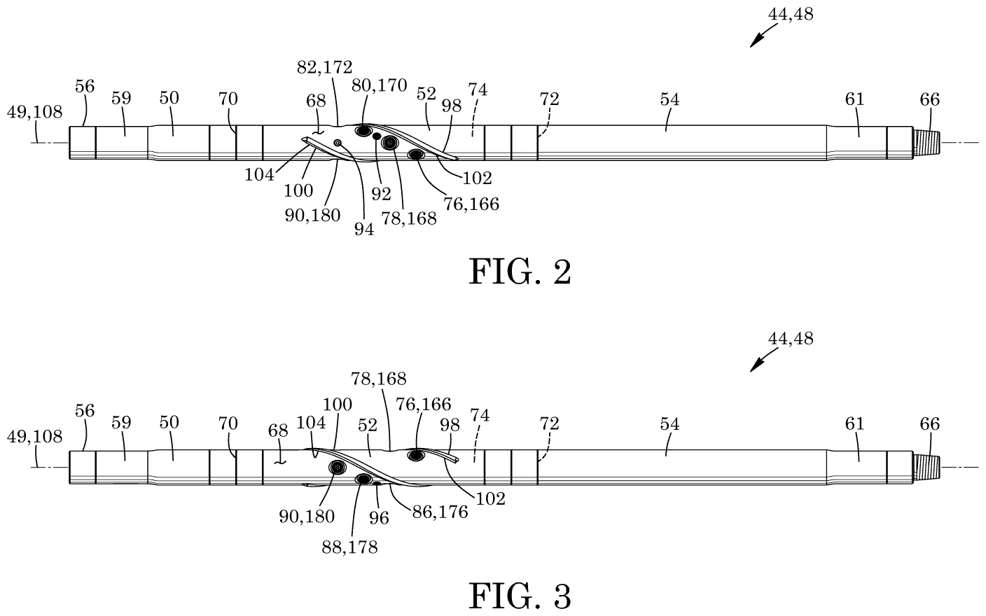

Referring back to FIG. 6, outer body 52 has an outer surface 68 and a bore 74 each extending between ends 70 and 72 thereof. The outer body may be referred to as a caliper subassembly which connects to standard drill pipe 43 seen in FIG. 1 thereabove via uphole crossover 50 and/or therebelow via downhole crossover 54. As seen with reference to FIGS. 2 to 6, outer body 52 is shaped to house a sensor tool, in this non-limiting embodiment a sensor tool, in this example a contactless sensor tool, in this case an acoustic sensor tool 106 described further below and enable acoustic measurements to be taken therethrough via strategically positioned apertures. The following is a non-limiting embodiment which achieves this functionality.

Outer body 52 has a plurality of first or primary apertures 76, 78, 80, 82 and 84, 86, 88 and 90. The apertures extend radially inwards from outer surface 68 of the outer body and are positioned between ends 70 and 72 of the outer body. The apertures are in fluid communication with bore 74 of outer body 52. Apertures 76, 78, 80, 82 are positioned in a first helical arrangement and apertures 84, 86, 88 and 90 are positioned in a second helical arrangement which angularly and/or spatially spaced from the first helical arrangement. The apertures as a whole may thus be said to be positioned in this non-limiting example in a double helix arrangement. As seen in FIG. 6, the apertures are arranged in a plurality of tiers, in this non-limiting embodiment four tiers T₁, T₂, T₃ and T₄. Each tier includes two or more apertures in this example, in this example two apertures as shown by tier T₁ comprising apertures 76 and 84. Tiers T₁, T₂, T₃ and T₄ are spaced-apart axially from one another along outer body 52. For each tier T₁ apertures 76 and 84 thereof are angularly spaced apart from each other by 180 degrees in this non-limiting example.

As seen in FIGS. 2 and 4, outer body 52 includes in this non-limiting embodiment at least one and in this example a plurality of additional or auxiliary apertures 92, 94 and 96 which are spaced-apart from the rest of the apertures. The auxiliary apertures extend radially inwards from outer surface 68 of outer body 52 and are in fluid communication with bore 74. Each of the apertures 76, 78, 80, 82, 84, 86, 88, 90, 92, 94 and 96 are circular in this example, with the auxiliary apertures being smaller in radius compared to the primary apertures in this non-limiting example; however this is not strictly required.

As seen in FIG. 6, wellbore measuring apparatus 44 includes at least one and in this example a pair of helical elongate members, in this case ribs 98 and 100. However, this is not strictly required and there may be one or three or more ribs in other non-limiting embodiments. As seen in FIGS. 2 to 5, the ribs couple to, extend about and extend radially outwards from outer surface 68 of outer body 52. Each of ribs 98 and 100 is helical in shape in this example. The ribs are shaped/configured to protrude outwards from outer subassembly 48. Ribs 98 and 100 are shaped to inhibit damage to wellbore measuring apparatus, including interior components thereof as well inhibiting outer body 52 of outer subassembly 48 from wearing. The ribs are shaped to space the outer body from wellbore 30 seen in FIG. 1. Referring back to FIGS. 2 to 5, ribs 98 and 100 may be referred to as wear bands. Apertures 76, 78, 80 and 82 align with, extend along and extend near and/or adjacent one side 102 of rib 98 in this example. Apertures 84, 86, 88 and 90 align with, extend along and extend near and/or adjacent to one side 104 of rib 100 in this example. The ribs are thus contoured to the spiral or helical arrangements of apertures on the outer body so as to centralize wellbore measuring apparatus 44 in the borehole while protecting the apertures from filling with debris. As seen in FIG. 6, ribs 98 and 100 may have tapered ends 98A and 98B and 100A and 100B, respectively; however, this is not strictly required. Each rib is configured to be selectively removable and/or redressable in this non-limiting embodiment. Each rib 98 and 100 may be referred to as a blade, a spiral blade and/or tapered blade with a bite edge that inhibits sensors within wellbore measuring apparatus 44 from being scraped or damaged by a rock or outer wall 46 of wellbore 30 seen in FIG. 1.

As seen in FIG. 6, wellbore measuring apparatus 44 includes an inner subassembly, in this example a sensor tool, in this non-limiting embodiment a contactless sensor tool, in this case acoustic sensor tool 106. This may be referred to as a probe or a main probe assembly of the wellbore measuring apparatus, which includes sensors, control boards, batteries, and all other components required for wellbore and/or drill string data gathering as will be discussed in greater detail below.

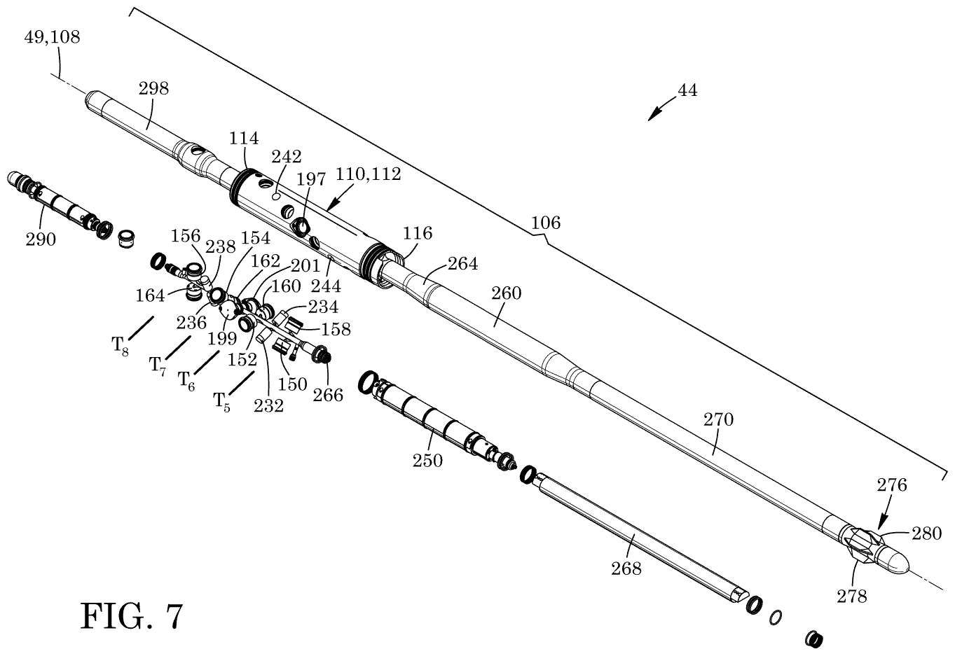

As seen in FIG. 7, acoustic sensor tool 106 is elongate and extends along and about longitudinal axis 108. The longitudinal axis of the acoustic sensor tool is coaxial with longitudinal axis 49 of outer subassembly 48 in this non-limiting example. Acoustic sensor tool 106 is generally cylindrical in outer shape in this non-limiting embodiment. As seen in FIG. 6, acoustic sensor tool 106 includes a sensor assembly 110. The sensor assembly is positioned to extend within outer body 52 at least in part.

Sensor assembly 110 is configured to selectively couple to and be removable from the outer body. Wellbore measuring apparatus 44 is configured such that any one of outer body 52 thereof, the sensor assembly thereof or both the outer body and the sensor assembly thereof, is selectively replaceable. The following is a non-limiting embodiment which achieves the above functionality.

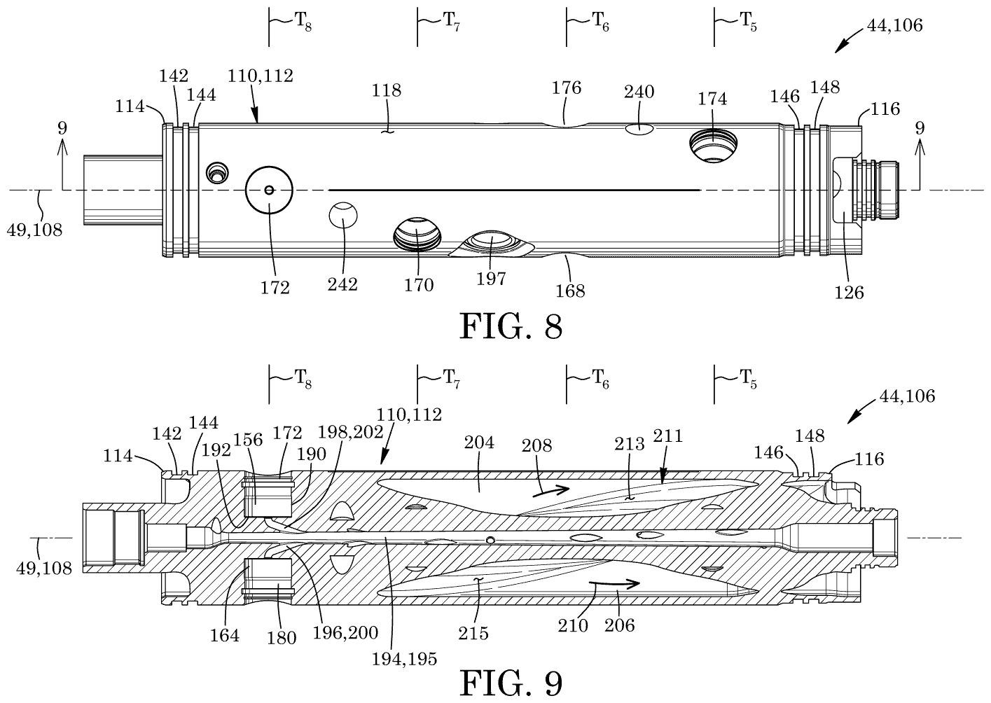

As seen in FIG. 8, sensor assembly 110 includes an inner body 112. The inner body of the sensor assembly is elongate and tubular in this non-limiting embodiment. Inner body 112 of sensor assembly 110 has a pair of spaced-apart ends 114 and 116 and an outer surface 118 extending between the ends thereof. The inner body of the sensor assembly is cylindrical in outer profile in this non-limiting example.

Referring to FIG. 13, inner body 112 of sensor assembly 110 is shaped to fit within bore 74 of outer body 52 seen in FIG. 12 and selectively sealably couple thereto. The following is a non-limiting embodiment which achieves this functionality.

Acoustic sensor tool 106 is selectively positioned within and coupled to outer body 52 in a manner which promotes a correct/preferred orientation of the acoustic sensor tool relative to the outer body. To this end wellbore measuring apparatus 44 includes a key member, in this example a caliper keying sleeve 120. The caliper keying sleeve is pressed into an axial bore 122 of outer body 52. Caliper keying sleeve 120 is shaped to mechanically engage with inner body 112 of sensor assembly 110, in this example via a protrusion 124 of the sleeve extending within an axially-extending aperture 126 of the inner body adjacent end 116 of the inner body. The caliper keying sleeve is thus press fit into outer body 52 in this example to ensure that acoustic sensor tool 106 remains correctly oriented within the outer body.

As seen in FIG. 12, sensor assembly 110 is thereafter threadably coupled to outer subassembly 48. In this non-limiting embodiment, wellbore measuring apparatus 44 includes a threaded member, in this example a castle nut 128 shaped to fit within bore 74, threadably couple to inner threading 130 of outer body 52 so as to abut end 114 of inner body 112 and inhibit axial movement of the inner body relative to the outer body. Referring to FIGS. 12 and 13, the inner threading, the castle nut and sensor assembly 110 so coupled to outer body 52, are positioned between and inwards from ends 70 and 72 of the outer body in this non-limiting example. Referring to FIG. 12, castle nut 128 may be referred to as a castle ring and may function to securely couple acoustic sensor tool 106 to outer body 52 of outer subassembly 48. Inner body 112 of sensor assembly 110 is thus configured to fit within and threadably couple to outer body 52 in this example.

Still referring to FIGS. 12 and 13, the inner body of the sensor assembly scalably couples to inner annular wall 132 of outer body 52 via at least two seals and in this example two pairs of seals, in this example O-rings 134/136 and 138/140. O-rings are seated within annular grooves 142/144 and 146/148 of inner body 112 adjacent ends 114 and 116 of the inner body.

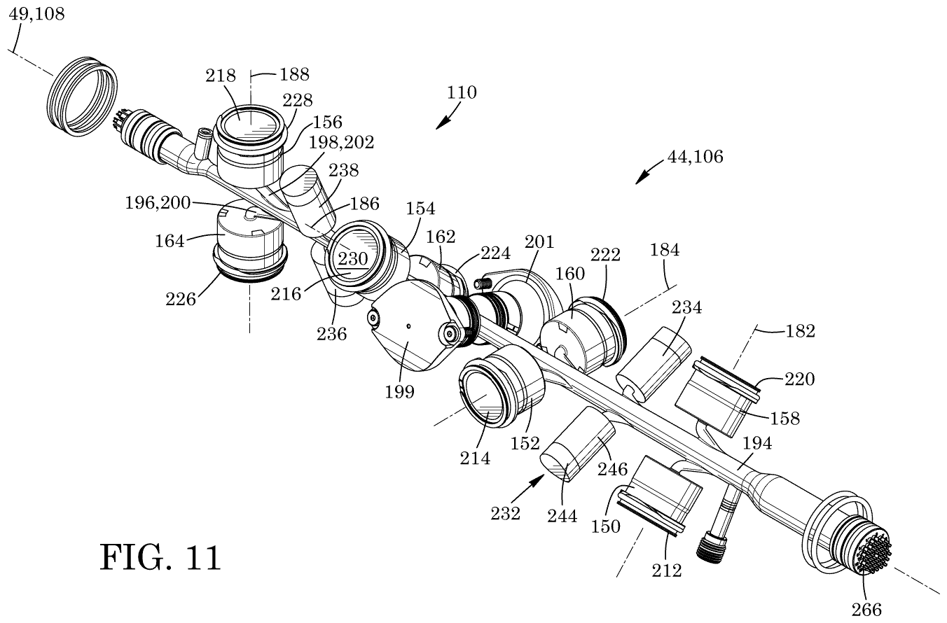

Referring now to FIG. 11, sensor assembly 110 includes a plurality of pairs of primary sensors, in this example contactless sensors, in this case eight acoustic sensors 150, 152, 154 and 156, and 158, 160, 162 and 164. However, this number is not strictly required and there may be fewer or more sensors (e.g. up to 16 in one non-limiting embodiment) arranged in one or more spiral and/or helical paths. The sensors are cylindrical in outer shape in this example, though this is not strictly required. As seen in FIG. 12, the sensors are positioned radially inwards from outer surface 68 of outer body 52 in this example. The sensors extend radially inwards from outer surface 118 of inner body 112 in this non-limiting embodiment. Sensors 150, 152, 154 and 156; and 158, 160, 162 and 164 seen in FIG. 7 are positioned between ends 114 and 116 of the inner body and between ends 70 and 72 of the outer body seen in FIG. 6.

Referring to FIG. 7, sensors 150, 152, 154 and 156 are positioned in a first helical arrangement and sensors 158, 160, 162 and 164 are positioned in a second helical arrangement which is angularly/spatially spaced from the first helical arrangement thereof. The sensors as a whole may thus be said to be positioned in this example in a double helix arrangement. The sensors are arranged in a plurality of tiers: in this non-limiting embodiment four tiers T₅, T₆, T₇ and T₈ which correspond/align with tiers T₁, T₂, T₃, T₄ of apertures 76/84, 78/86, 80/88, 82/90 seen in FIGS. 2 to 6. Each of tiers T₅, T₆, T₇ and T₅ comprises two or more sensors in this example, in this case two sensors: tier T₅ comprises sensors 150/158; tier T₆ comprises sensors 152/160; tier T₇ comprises sensors 154/162; and tier T₅ comprises sensors 156/164. Tiers T₅, T₆, T₇ and T₈ are spaced-apart axially from one another. For each tier T₅ sensors 150 and 158 thereof are angularly spaced apart from each other by 180 degrees in this non-limiting example.

Each sensor 150, 152, 154, 156, 158, 160, 162 and 164 is arranged to measure at least one characteristic of wellbore. The latter may comprise one or more wellbore diameters so as to obtain data for determining a three-dimensional (3D) image of wellbore 30 seen in FIG. 1 and/or the shape of wellbore wall 46, for example. Wellbore measuring apparatus 44 with its sensors thereof so arranged, may thus be configured to measure simultaneously the diameter(s) of the wellbore at four adjacent lateral sections thereof. Where the wellbore measuring apparatus includes additional sensors, such as sixteen sensors in one non-limiting embodiment, the sensors thereof may be arranged to measure simultaneously the diameter(s) of the wellbore at up to eight adjacent lateral sections thereof, for example.

Acoustic sensors 150, 152, 154, 156, 158, 160, 162 and 164 as herein described may comprise piezoelectric materials in one non-limiting example. The acoustic sensors generate signals by moving a diaphragm back and forth so as to displace fluid around the diaphragm, thereby creating acoustic waves. These waves can be used to measure distance. Acoustic sensors per se, including their various parts and functionings, are known per se and thus will not be described in further detail.

The acoustic sensors are angularly spaced relative to outer body 52 seen in FIG. 6. Referring to FIGS. 2 to 7, the sensors 150, 152, 154, 156, 158, 160, 162 and 164 align and are positioned in communication with respective ones of apertures 76, 78, 80, 82, 84, 86, 88 and 90 of the outer body.

The sensors are enclosed or encased in this example. Inner body 112 of sensor assembly 110 is configured to receive sensors 150, 152, 154, 156, 158, 160, 162 and 164 therewithin in a sealed configuration to inhibit external pressures from damaging the sensors. The following is a non-limiting example which provides this functionality.

As seen in FIGS. 2 to 5, 8 and 9, inner body 112 of sensor assembly 110 has a plurality of first or primary recessed portions 166, 168, 170, 172, 174, 176, 178 and 180. Each recessed portion is annular in this example. The recessed portions extend radially inwards from outer surface 118 of the inner body to longitudinal axis 108. The recessed portions are positioned between ends 114 and 116 of inner body 112 of sensor assembly 110 in this example. Recessed portions 166, 168, 170, 172 are positioned in a first helical arrangement and recessed portions 174, 176, 178 and 180 are positioned in a second helical arrangement that is angularly/spatially spaced from said first helical arrangement. The recessed portions as a whole may thus be said to be positioned in this example in a double helix arrangement.

As seen in FIG. 8, the recessed portions are arranged in a plurality of tiers, in this non-limiting embodiment tiers T₅, T₆, T₇ and T₅ which correspond/align with tiers T₁, T₂, T₃, T₄ of apertures 76/84, 78/86, 80/88, 82/90 seen in FIGS. 2 to 6. As seen in FIGS. 2 to 5 and 8, each of tiers T₅, T₆, T₇ and T₈ comprises two or more recessed portions in this example, in this case two recessed portions: tier T₅ comprises recessed portions 166/174; tier T₆ comprises recessed portions 168/176; tier T₇ comprises recessed portions 170/178; and tier T₅ comprises recessed portions 172/180. Tiers T₅, T₆, T₇ and T₈ are spaced-apart axially from one another. As seen in FIG. 9, for each tier T₈ recessed portions 172/180 thereof are angularly spaced apart from each other by 180 degrees in this non-limiting example.

Referring to FIGS. 2 to 5 and 11, apertures 76/84, 78/86, 80/88, 82/90 of outer body 52, recessed portions 166/174, 168/176, 170/178 and 172/180 of inner body 112 of sensor assembly 110 and sensors 150/158, 152/160, 154/162 and 156/164 align with each other, respectively, via respective lateral axes 182, 184, 186 and 188 seen in FIG. 11. Each lateral axis extends laterally or radially-outwards relative to longitudinal axes 49 and 108 in this example. Adjacent lateral axes 182 and 184 are angularly spaced from each other in this non-limiting example as a function of 360 degrees divided by two times the number of tiers, in this case being angularly spaced from each other by 45 degrees. However, this is not strictly required the tiers may be angularly spaced-apart from each other by other amounts or integers thereof in other embodiments.

Inner body 112 of sensor assembly 110 is shaped to substantially enclose the bottom and sides of each sensor, in this example via respective recessed portions shaped to receive its sensor therewithin: this is shown in FIG. 12 by recessed portion 172 substantially receiving sensor 156 and enclosing annular side 190 and bottom 192 of the sensor.

As seen in FIG. 9, inner body 112 of sensor assembly 110 includes a first passageway or bore, in this example a wiring pathway 194 extending therethrough between ends 114 and 116 thereof. The wiring pathway is coaxial with and extends along axes 49 and 108 in this non-limiting example. Wiring pathway 194 is shaped to receiving wiring 196 and 198 from respective ones of sensors 156 and 164 therethrough. The wiring is directed to the wiring pathway via a plurality of pairs of connecting passages or branches 200 and 202 per tiered pair of sensors 156 and 164. The branches are radially extending and in this example longitudinally-extending in part. Each branch in this non-limiting embodiment is angularly spaced-from wiring pathway 194 and/or axes 49/108, in this example extending angularly outwards by angle α which is acute; however, this is not strictly required.

Sensors 156 and 164 and wiring pathway 194 are in fluid communication via their respective branches 200 and 202. Each branch 202 extends from adjacent bottom 192 of corresponding sensor 156 to the wiring pathway. The branches are positioned in helical or spirally arrangements, in this example double helix arrangements about wiring pathway 194 in this non-limiting example as seen in FIG. 11.

Inner body 112 of sensor assembly 110 is configured to maintain a pressure balance therewithin for sensors 150, 152, 154, 156 and 158, 160, 162 and 164 thereof seen in FIG. 11. To this end pathway 194 (including branches 200 and 202 thereof) is filled with fluid 195 for internal pressure compensation. Referring to FIG. 8, the fluid comprises oil in this non-limiting example which is in fluid communication with at least one and in this example a pair of radially-outwardly extending bores 197 of inner body 112 of sensor assembly 110. The bores are positioned between recessed portions 168 and 170 in this non-limiting example. Pressure caps 199 and 201 seen in FIG. 7 threadably couple to respective bores 197. The bores (accessible via the pressure caps) each comprise a tap for the entrance of fluid 195 seen in FIG. 9 that encases pathway 194 and associated wiring extendable therewithin. The fluid functions to pressure compensate the system including sensors 150, 152, 154, 156 and 158, 160, 162 and 164.

Still referring to FIG. 11, inner body 112 of sensor assembly 110 is configured to seal sensors 150, 152, 154, 156 and 158, 160, 162 and 164 from drilling fluid passing internally through wellbore measuring apparatus 44 towards bottom 41 of wellbore 30 seen in FIG. 1 and passing externally about wellbore measuring apparatus 44 back towards surface 37 seen in FIG. 1 once more. The following is non-limiting example of sensor assembly 110 with this functionality.

As seen in FIG. 12, each sensor 156 is sealably coupled to corresponding recessed portion 172 of inner body 112 of sensor assembly 110 via one or more seals, in this example via an O-ring 203. The O-ring is seated within the inner body of the sensor assembly so to be in communication with its corresponding recessed portion 172. O-ring 203 is near or adjacent top 228 of sensor 156 in this non-limiting embodiment. Wellbore measuring apparatus 44 as herein described may be referred to as solid-state technology which has no or substantially no moving parts in one non-limiting embodiment.

Referring to FIG. 1, wellbore measuring apparatus 44 is shaped to enable/facilitate the passing of drilling fluid therethrough. The wellbore measuring apparatus is thus configured to enable data collection of one or more characteristics of wellbore 30 without interrupting drilling operations, such as logging while drilling (LWD) in one non-limiting example. The following is a non-limiting embodiment which achieves this functionality.

As seen in FIG. 9, inner body 112 of sensor assembly 110 has at least one additional passageway extending therethrough, in this non-limiting example a pair of additional passageways, in this case second and third passageways 204 and 206. The second and third passageways of the inner body of the sensor assembly are shaped to enable/facilitate passing of drilling fluid therethrough, as shown by arrows of numerals 208 and 210, towards bottom 41 of wellbore 30 seen in FIG. 1. Referring back to FIG. 9, each passageway 204 and 206 may be referred to as an inner passageway or alternatively passageways 204 and 206 collectively may be referred to as an inner passageway. The second and third passageways extend between ends 114 and 116 of inner body 112 of sensor assembly 110 and are thus positioned between ends 70 and 72 of outer body 52 seen in FIG. 6 in this non-limiting example. Referring back to FIG. 9, each of passageways 204 and 206 is helical in shape in this non-limiting embodiment, with the passageways thus collectively forming a double helix shape.

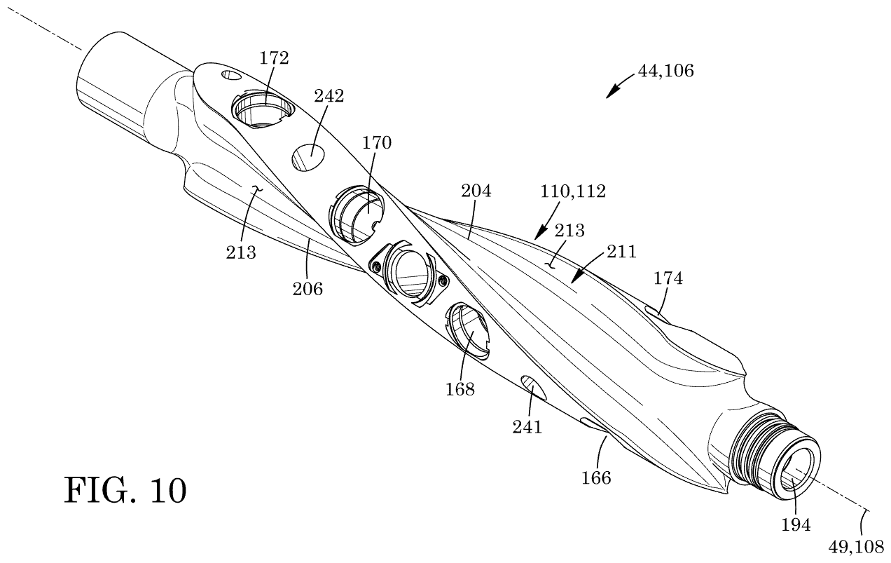

As seen in FIG. 10, inner body 112 of sensor assembly 110 includes a centrally-extending member, in this example an inner housing 211. The inner housing is generally in the shape of a twisted or spiralled rectangular prism in this non-limiting embodiment. Inner housing 211 has a pair of opposite, longitudinally-extending, radially outwardly-facing sides 213 and 215 in communication with and which define portion of respective ones of passageways 204 and 206. Each side is rectangular in outer profile and twisted in this non-limiting example. Each of sides 213 and 215 is curved at least in part in lateral section in this non-limiting example.

As seen in FIG. 11, sensor assembly 110 includes a plurality of sensor covering members, in this example sensor covers 212, 214, 216, 218, 220, 222, 224 and 226. The sensor covers are circular in this non-limiting embodiment and may be referred to as and/or comprise sensor screens. Sensor covers 212, 214, 216, 218, 220, 222, 224 and 226 are configured to protect and enclose respective ones of sensors 150, 152, 154, 156, 158, 160, 162 and 164. For each sensor 156 sensor cover 218 thereof is configured to inhibit access thereto, in this example spanning top 228 of the sensor and inhibiting access thereto. For each sensor the sensor cover thereof is configured to enable one or more signals thereof to selectively pass therethrough. Sensor covers 212, 214, 216, 218, 220, 222, 224 and 226 thus function to protect the sensors on the one hand while allowing/facilitating measurement of wellbore 30 seen in FIG. 1 on the other hand.

As seen in FIG. 12, sensor covers 218 and 226 are shaped in this example to fit within respective ones of apertures 82 and 90 of outer body 52. Each sensor cover may be substantially similar in span and/or coextensive with its respective aperture in one non-limiting embodiment. Sensor covers 218 and 226 may selectively couple to and be removable from respective ones of sensors 156 and 164. In this case each sensor cover threadably couples to outer body 52 via exterior peripheral threading 219 thereof which engages with interior threading 221 of the outer body. The interior threading faces, is in communication with and extends inwards towards corresponding aperture 90 in this example. Each sensor cover 218 is thus shaped to extend along and scal off top 228 of its corresponding sensor 156 in this example, with inner body 112 of sensor assembly 110 enclosing and sealing off the rest of the sensor. Referring to FIG. 11, each sensor cover 216 in this non-limiting example comprises a window 230. The windows are configured to facilitate visual inspection of sensors 154 therewithin.

Referring to FIGS. 9 and 11, inner body 112, with its pathway 194 and passageways 204 and 206 and sensor covers 212, 214, 216, 218, 220, 222, 224 and 226 thereof, is thus shaped to enable to seal sensors 150, 152, 154, 156, 158, 160, 162 and 164 from drilling fluid and inhibit damage to the sensors, while facilitating passageway of drilling fluid therethrough and thereabout. The fluid filled wire pathway allows wires to connect to sensors.

As seen in FIGS. 2 to 5, ribs 98 and 100 are configured to further inhibit the sensors from being damaged by wellbore 30 shown in FIG. 1. Sensors 150, 152, 154 and 156 seen in FIG. 11 align with, extend along and extend near and/or adjacent side 102 of rib 98 seen in FIGS. 2 to 5 in this example. Sensors 158, 160, 162 and 164 seen in FIG. 11 align with, extend along and extend near and/or adjacent to side 104 of rib 100 seen in FIGS. 2 to 5 in this example.

The sensors are configured to collect data pertaining to one or more characteristics of wellbore 30 seen in FIG. 1 while drill string 42 is being removed from the wellbore. In addition or alternatively, sensors 150, 152, 154, 156, 158, 160, 162 and 164 seen in FIG. 11 may be configured to collect data pertaining to one or more characteristics of the wellbore while the drill string is being inserted into the wellbore. The sensors are positioned to obtain a full geometry of wellbore 30 seen in FIG. 1 by collecting all (or substantially all) equally spaced radial data measuring points thereof.

As seen in FIG. 11, sensor assembly 110 in this non-limiting example includes one or more and in this example a pair of pressure sensor 232 and 234 spaced-apart by 180 degrees; however, this is not strictly required.

The sensor assembly includes in this non-limiting embodiment one or more and in this example a pair of thermal sensor 236 and 238 spaced-apart by 180 degrees, though here too this is not strictly required. The thermal sensors may in one non-limiting example be positioned externally so as to facilitate detection and/or a determination of thermal variances within the wellbore.

The pressure and thermal sensors are radially inwardly spaced from outer surface 68 of outer body 52 seen in FIG. 6. Sensors 232/234 and 236/238 seen in FIG. 11 are positioned within corresponding recessed portions 240/241 and 242 of inner body 112 of sensor assembly 110 seen in FIGS. 8 and 10. The sensors align with corresponding apertures 92 and 96 of outer body 52 seen in FIGS. 2 and 3 in a like manner as described above to protect the sensors on the one hand, while enabling signals to selectively pass therethrough on the other hand.

There may be provided plugs which enable pressure sensors 232/234 and/or thermal sensors 236/238 seen in FIG. 11 to read a measurement through outer body 52 seen in FIG. 6. Referring to FIG. 7, each sensor 232 may include in this non-limiting example a piston plug 244 configured to allow pressure to be transmitted to a pressure compensation piston 246 seen in FIG. 11. The test port plug seals off the test port once it has been confirmed that sensor assembly 110 is sealed within outer body 52 seen in FIG. 6. Thermal and pressure sensors per se, including their various parts and functions, are known per se and sensors 232, 234, 236 and 238 seen in FIG. 11 will accordingly not be described in further detail.

Referring now to FIG. 7, acoustic sensor tool 106 includes in this non-limiting example a memory-based logging unit 250 operatively connected to sensors 150, 152, 154, 156, 158, 160, 162, 164, 232, 234, 236 and 238. The logging unit may be referred as to as an acoustic sensor tool chassis assembly. As seen in FIG. 13, logging unit 250 includes a circuit board 251 and a processor 252 thereon. The logging unit comprises the circuit board and housing that runs acoustic sensor tool 106 in this non-limiting example. Processor 252 is configured to receive electrical output signals from sensors 150, 152, 154, 156, 158, 160, 162, 164, 232, 234, 236 and 238 seen in FIG. 11 indicative of one or more characteristics of wellbore 30 seen in FIG. 1 and to log the output signals. Referring back to FIG. 13, the processor is configured in one non-limiting example to log the output signals during static or non-drilling conditions.

Still referring to FIG. 13, logging unit 250 includes firmware 254 to process via processor 252 the output signals from the sensors to determine one or more characteristics of wellbore 30 seen in FIG. 1, such as the profile thereof. Referring back to FIG. 13, the processor is in one non-limiting example configured to create a pre-determined wave function to match the receiving signal of one or more sensors 150, 152, 154, 156, 158, 160, 162, 164, 232, 234, 236 and 238 seen in FIG. 11, for a more defined reading. Referring back to FIG. 13, logging unit 250 includes a memory 256 in communication with processor 252 and firmware 254 and within which data may be selectively stored and retrieved. The memory in this example stores machine instructions that, when executed by processor 252, cause the processor to perform one or more of the operations and methods described herein and/or store data collected by sensors 150, 152, 154, 156, 158, 160, 162, 164, 232, 234, 236 and 238 seen in FIG. 11. Referring back to FIG. 13, logging unit 250 includes various electronics 257 configured to transmit data gathered by the sensors to surface equipment (e.g. via a suitable telemetry transmitter), store or log readings from the sensors and/or process outputs of the sensors to yield information specifying a profile of a wall and/or intermediate data.

Ribs 98 and 100 seen in FIGS. 2 to 5 are configured to stabilize wellbore measuring apparatus 44 in wellbore 30 seen in FIG. 1 to inhibit shock and vibration damage to the electronics during drilling operations.

Referring back to FIG. 13, logging unit 250 in this non-limiting example includes an inner housing 258 within which is positioned processor 252, firmware 254 and memory 256. The logging unit in this non-limiting embodiment includes an outer housing 260 within which the inner housing is received. Inner housing 258 sealably couples to the outer housing in this example via at least one and in this case a plurality of longitudinally spaced-apart seals or O-rings 262.

Sensor assembly 110 operatively connects to logging unit 250 so as to enable communication between components thereof. In this non-limiting example the sensor assembly couples to the logging unit via an elongate coupler 264 including a bulkhead connector 266 therewithin. Elongate couplers and bulkhead connectors, including their various parts and functionings, are known per se and coupler 264 and connector 266 will accordingly not be described in further detail.

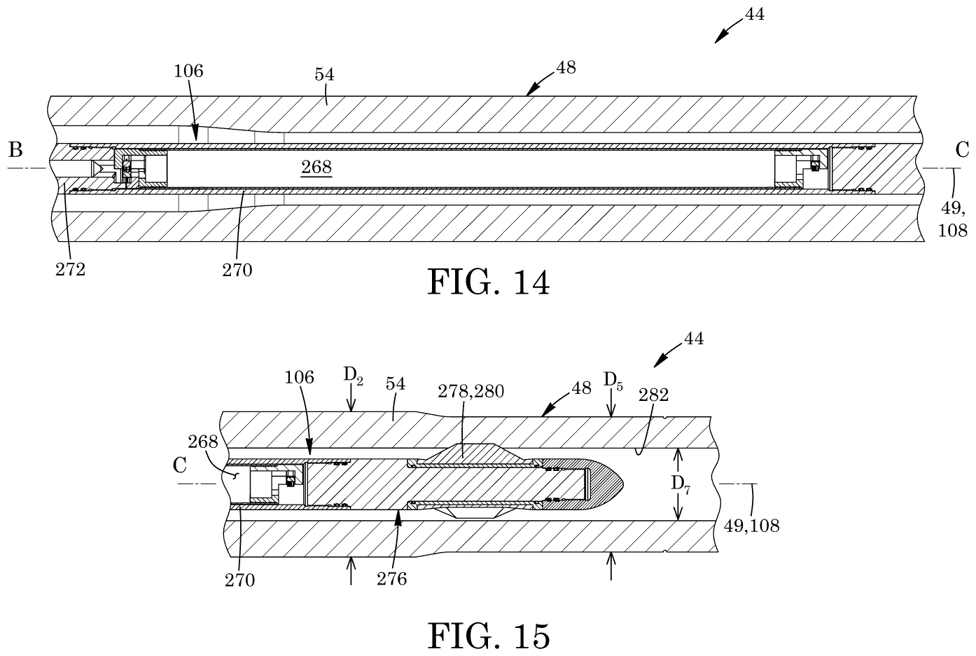

As seen in FIG. 7, wellbore measuring apparatus 44 includes a power source, in this example a battery 268. The battery operatively connects to and provides power to the acoustic sensor tool 106. Battery 268 may be said to a part of the acoustic sensor tool in one non-limiting example. As seen in FIG. 14, battery 268 in this example is enclosed within a battery housing 270. Sensor assembly 110 and logging unit 250 operatively connect to the battery so as to receive power therefrom. In this non-limiting example and as seen in FIG. 13, logging unit 250 couples to the battery via an elongate coupler 272 including a rotatable electronic connector 274 therewithin. The rotatable electrical connector connects battery 268 to circuit board 251 seen in FIG. 13 and the rest of acoustic sensor tool 106. The battery may be configured to last up to one month in one non-limiting example. Rotatable electronic connectors, including their various parts and functionings, are known per se and connector 274 will accordingly not be described in further detail.

Referring now to FIG. 6, acoustic sensor tool 106 includes a longitudinally-extending centralizer assembly or unit 276 which includes a centralizer 278. As seen in FIG. 15, the centralizer extends within downhole crossover 54 and is configured to keep the acoustic sensor tool secured and centralized within the collar. Centralizer 278 in non-limiting embodiment may comprise a plurality of radially-outwardly extending vanes 280 which slidably-abut and/or interference-fit-engage with inner surface 282 of downhole crossover 54. The vanes may be made of a resilient material such as rubber or the like; however, the latter is not strictly required. Centralizer assemblies including centralizers thereof and their various parts and functionings, are known per se and centralizer unit 276 and centralizer 278 will accordingly not be described in further detail.

As seen in FIG. 12, acoustic sensor tool 106 includes a calibration sensor, in this example an acoustic calibration sensor 284. The acoustic calibration sensor is configured to measure a known distance from sensor face 286 to inner surface 132 of outer body 52 seen in FIG. 13. Acoustic calibration sensor 284 seen in FIG. 12 thereby calibrates sensors 150, 152, 154, 156, 158, 160, 162, and 164 seen in FIG. 11 to one or more characteristics of the currently-used drilling fluid. Referring to FIG. 12, acoustic sensor tool 106 includes a coupler 288 with a radially inwardly-extending recessed portion 290 shaped to receive the acoustic calibration sensor therewithin in this non-limiting example. Acoustic calibration sensor 284 is in communication with logging unit 250 including processor 252 thereof seen in FIG. 13. Calibration sensors per se, including their various parts and functionings, are known per se and acoustic calibration sensor 284 seen in FIG. 12 will accordingly not be described in further detail.

Referring now to FIG. 7, acoustic sensor tool 106 includes a wireless unit, in this example a Wi-Fi™ module 290 operatively connected to logging unit 250 seen in FIG. 13. Referring back to FIG. 7, the Wi-Fi™ module is configured to transmit signals representing the measurements obtained by sensors 150, 152, 154, 156, 158, 160, 162, 164, 232, 234, 236 and 238 of acoustic sensor tool 106 seen in FIG. 11 to an operator at surface 37 seen in FIG. 1. The following is a non-limiting embodiment which achieves this functionality.

As seen in FIG. 12, Wi-Fi™ module 290 extends longitudinally so as to fit at least in part within uphole crossover 50 in this non-limiting embodiment. Wi-Fi™ module 290 includes a Wi-Fi™ circuit board 292 and a transmitter 293 and/or receiver 295 as are commonly known. Transmitter/receiver may be controlled to transmit signals representing the measurements obtained by sensors 150, 152, 154, 156, 158, 160, 162, 164, 232, 234, 236 and 238 of acoustic sensor tool 106 seen in FIG. 11 to an operator at surface 37 seen in FIG. 1. In such embodiments transmitter 293 and/or receiver 295 seen in FIG. 12 may optionally receive commands from surface equipment that are recognized by processor 252 seen in FIG. 13.

Referring back to FIG. 12, Wi-Fi™ module 290 in this non-limiting example includes an inner housing 294 within which is positioned Wi-Fi™ circuit board 292 and other electronics configured to enable wireless communication/transmission. The Wi-Fi™ module in this non-limiting example includes an outer housing 296 within which the inner housing is received. Inner housing 294 sealably couples to the outer housing in this example via at least one and in this case a plurality of longitudinally spaced-apart seals or O-rings 298.

Wi-Fi™ module 290 in this non-limiting example includes an antenna 300 operatively connected to the Wi-Fi™ circuit board 292 together with related electrical components including transmitter 293 which provides power and signals to the antenna. The antenna in this non-limiting embodiment scalably couples to outer housing 296 via a threaded member 302 and spaced-apart seals, in this case O-rings 304 and 306. Wi-Fi™ module 290 operatively connects to logging unit 250 including processor 252 thereof seen in FIG. 13. In response thereto, antenna 300 is configured to wirelessly offload data from acoustic sensor tool 106. Logging unit 250 seen in FIG. 13 transfers data acquired from sensor assembly 110 wirelessly to surface 37 seen in FIG. 1 for full wireless data transfer. Wi-Fi™ modules per se, including their various parts and functionings, are known per se and Wi-Fi™ module 290 seen in FIG. 7 will accordingly not be described in further detail.

Referring to FIG. 7, logging unit 250 in one non-limiting example is configured to log wellbore data during static wellbore conditions. The logging unit is configured to log wellbore data related to physical conditions of wellbore 30 seen in FIG. 1, including one or more of internal dimeter readings and temperature readings of the open hole wellbore. Wellbore measuring apparatus 44 is configured for logging while tripping (LWT) in this non-limiting embodiment and may thus be referred to as a LWT unit 45 or LWT device. The LWT unit may be referred to or comprise a probe based sub/mini stabilizer unit with multi-sensing capabilities. LWT unit 45 may be configured to remain dormant while drilling and only be activated before and/or for tripping back to the surface in one example. Wellbore measuring apparatus 44 may be said to comprise a LWT bottom hole assembly. The LWT bottom hole assembly may remain part of the drilling assembly and may only activated to log a wellbore during static (non-drilling) conditions and procedures in one non-limiting embodiment. In addition or alternatively, wellbore measuring apparatus 44 may be configured for logging while drilling (LWD).

Sensors 150, 152, 154, 156, 158, 160, 162 and 164 seen in FIG. 11 are arranged to generate via processor 252 seen in FIG. 13, an integrated 3D mesh model of wellbore 30 seen in FIG. 1. The sensors are arranged (in this example in a spiral and/or helical arrangement) to facilitate generation of a 3D model of a wellbore having an irregular shape, which may be referred to as an irregular wellbore. Referring back to FIG. 11, sensors 150, 152, 154, 156, 158, 160, 162 and 164 so positioned in helical arrangements may enable extra sensor density to fill in the data for a wellbore having an irregular shape. The sensors are configured to obtain an even number of radial measurements, with each pair of said radial measurements being 180 degrees apart to obtain diameters that create wellbore inner dimension readings which are translated into a 3D wellbore mesh.

Firmware 254 seen in FIG. 13 is configured to obtain via processor 252 a 3D well bore mesh point and generate a point cloud system based on the output signals. The firmware may be configured to determine via the processor one or more actual borehole volumes based on the output signals. Firmware 254 and/or advanced math, may be configured/used to determine via processor 252 where to place equipment in wellbore 30 seen in FIG. 1 based on the output signals. Referring back to FIG. 13, the firmware may be configured to apply well construction math via the processor to particular wellbore equipment and associated wellbore diameter tolerances so determined based on the output signals, so as to inhibit geomechanical activity responsible for damaging downhole completion equipment including well casing thereby. Wellbore measuring apparatus 44 may be configured with telemetry that facilitates data transfer to surface 37 seen in FIG. 1 for real time applications on work over well operations. The firmware is a Geonomic™ data analytic suite which performs all these functions once the data is offloaded at the surface in this non-limiting example and these are all post drilling operations which are facilitated in the Geonomic™ software suite.

Referring to FIG. 1, wellbore measuring apparatus 44 as herein described and so configured may enable an operator to log wellbore data while drill string 42 is moved towards bottom 41 of wellbore 30 to determine time dependent changes in the wellbore on each bit run, and determine volumes of drilling fluid seeped into the formation while a standing mud column remains in the borehole. The wellbore measuring apparatus as herein described and so configured may enable a workover rig to log a well casing on bottom hole assembly 38 or wireline unit on the way down to the bottom of the wellbore in order to avoid multiple trips in and out of the wellbore.

Wellbore measuring apparatus 44 may be configured to obtain the impedance of the drilling fluid while downhole with a fluid chamber and fixed distance with a piezo sensor for a full unmanned system. A drill fluid reading at surface 37 seen in FIG. 1 may function to back up standard information if the fluid reservoir is plugged off with sediment. Another calibration unit according to one non-limiting embodiment includes a surface station containing a substantially similar piezo sensor as that of wellbore measuring apparatus 44. The calibration unit may be fillable with mud from the outflow at a shaker to provide accurate drilling fluid sound wave velocity. Wellbore measuring apparatus 44 may be configured to enable calibration of wave velocity while down hole on drilling fluid, due to a position of a sensor with a pseudo echo chamber.

Referring to FIG. 12, acoustic sensor tool 106 may include a protective cap 301 with a substantially similar impedance ratio to the fluid in sensor assembly 110 to match acoustic impedance so as to not create attenuation and reflection of the signal. The wellbore measuring apparatus may include a material, such as ultra-high-molecular-weight polyethylene (UHMWPE) spectra fibre, used as a protective layer that also matches the impedance of the sensing assembly.

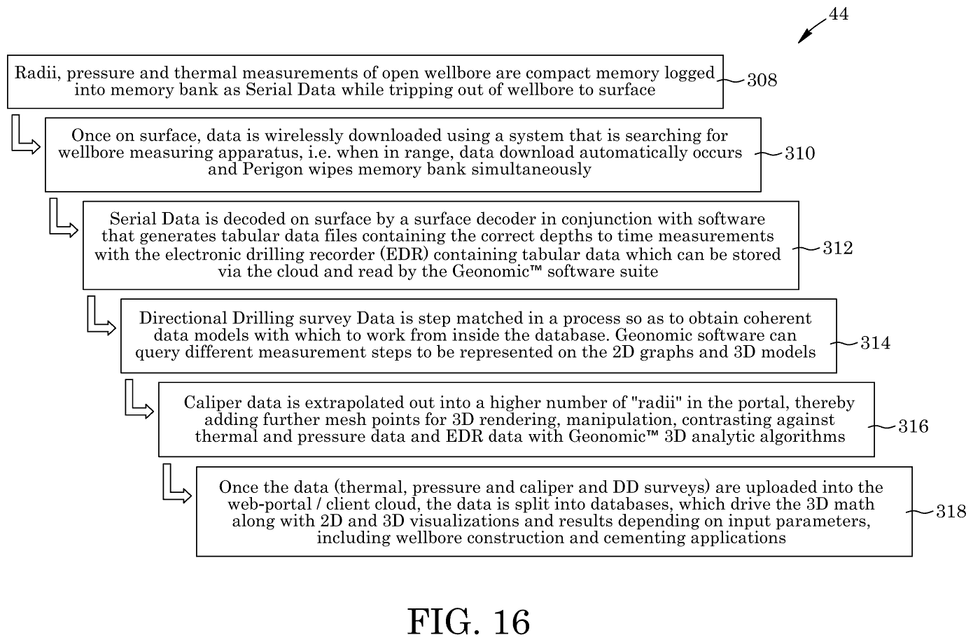

Referring to FIG. 16, the following is a non-limiting algorithm and/or method for operation of wellbore measuring apparatus 44. As shown by box 308, the method includes obtaining radii, pressure and/or thermal measurements of the wellbore via the wellbore measuring apparatus as herein described and thereafter storing this data in compact memory logged as serial data while tripping out of the wellbore to the surface. As shown by box 310, the method may include once on the surface, wirelessly downloading the data so obtain/stored from the firmware using a system that is searching for the firmware, that is, when in range, with the data being downloaded automatically and the memory banks of the firmware being deleted thereafter.

As shown by box 312, the method may include decoding the serial data so transmitted on the surface by a surface decoder in conjunction with software that generates tabular data files containing the correct depths to time measurements with an electronic drilling recorder (EDR) containing tabular data that can be stored via the cloud and read by software. As shown by box 314, the method may include step matching the directional drilling survey data in a process so as to obtain coherent data models to work from inside the database, with the software querying different measurement steps to be represented on two-dimensional (2D) graphs or three-dimensional (3D) models.

As shown by box 316, the method may include extrapolating the caliper data so obtained into a higher number of radii in the portal, which adds additional mesh points for 3D rendering, manipulation, contrasting against thermal and pressure data, and EDR data with proprietary analytic algorithms. As shown by box 318, the method may include, once the data (thermal, pressure, caliber and directional driller (DD) surveys) is uploaded into a web-portal/client cloud, splitting the data into one or more databases which drive the 3D math along with 2D and 3D visualizations and results depending on input parameters, including wellbore construction and cementing applications.

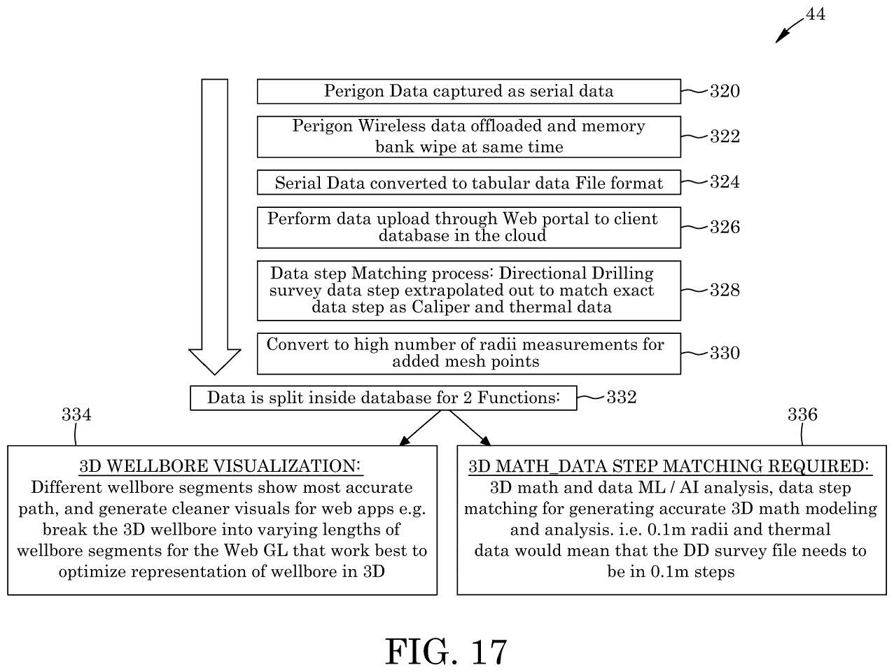

Referring to FIG. 17, the following is another non-limiting algorithm or method for operation of wellbore measuring apparatus 44 or another articulation of the same. As shown by box 320, the method may include capturing data from the wellbore measuring apparatus as serial data. As shown by box 322, the method may next include offloading the data and wiping the memory bank shortly thereafter. As shown by box 324, the method may next include converting the serial data into a tabular data file format. As shown by box 326, the method may next include uploading the data so converted through a web portal to a client database in the cloud. As shown by box 328, the method may next include a data step matching process of step extrapolating directional drilling survey data out to match exact data step as caliper and thermal data.

As shown by box 330, the method may next include converting to a high number of radii measurements for added mesh points. As shown by box 332, the method may next include splitting the data inside the database for two functions. As shown by box 334, the first function may comprise 3D wellbore visualization: the method may include visually different wellbore segments to show a most accurate path and generate cleaner visuals for web applications. This method may include breaking the 3D wellbore so visualized into varying lengths of wellbore segments via an application program interface for rendering interactive 2D/3D graphics, such as for example WebGL™, which may promote/result-in an improved/enhanced/superior representation of the wellbore in 3D. As shown by box 336, the second function may involve where 3D math data step matching is required. In this case for 3D math and data machine learning (ML)/artificial intelligence (AI) analysis, data step matching may be required to generate accurate 3D math modeling and analysis. For example, 0.1 m radii and thermal data may mean that the DD survey file (an image file created out of DD commands) needs to be in 0.1 m steps.

The wellbore measuring apparatus is configured in one example to log an open hole or wellbore, with a multi x-y caliper and multi sensor variance log via compact memory while pulling drill pipe back to the surface. The log provides a 360 degree geometrical, thermal and pressure view of the open borehole, in this example after each drill section total depth (TD). Data is converted into 3D models for rapid/real-time analysis thereof, which may drive accurate and efficient wellbore engineering. This may in turn directly increase production and the life of the well.

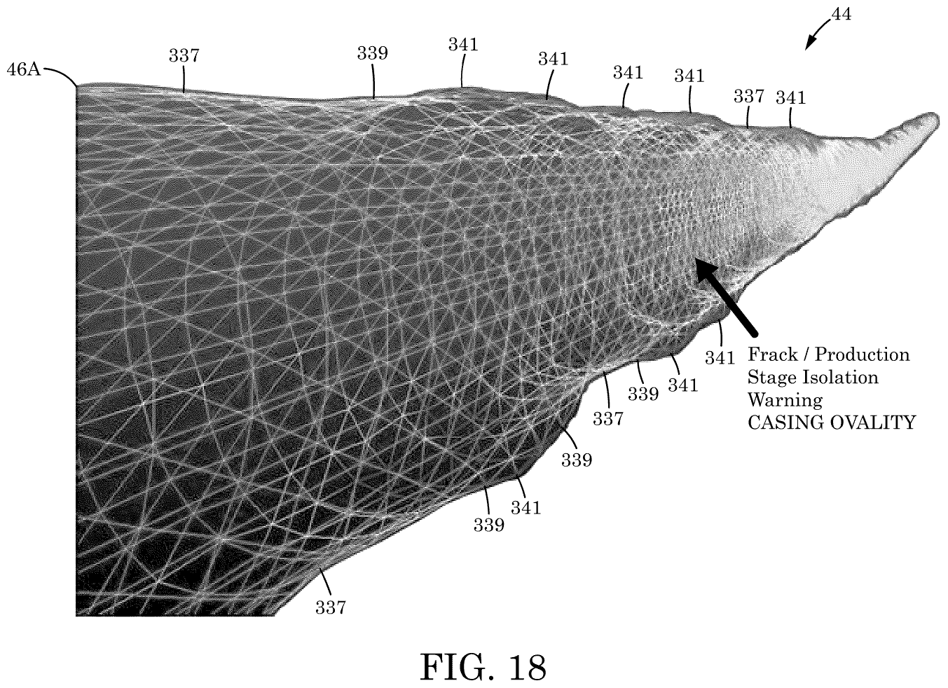

Wellbore measuring apparatus 44 as herein described is configured to enabling 3D mapping of each open borehole section or wellbore prior to wellbore construction as shown by FIG. 18. In one non-limiting embodiment, 2D data is converted via a processor into polygon (PLY) file format files, which can be read with point cloud readers software to display in 3D mesh or four point cloud which enable 3D analytics. Thus, the data obtained by wellbore measuring apparatus 44 may be received by a processor and converted to a 3D mesh or representation of the wellbore so as to facilitate subsequent wellbore construction and/or completion operations. The image/representation 46A of the wellbore is shown in this non-limiting example formed by a plurality of tetrahedron shapes. Wellbore measuring apparatus 44 as herein described is configured to obtain an estimate/determine of the volume of the wellbore which may be up 99% accurate according to one non-limiting example.

Image/representation 46A of the wellbore and data associated therewith may convey to an operator/engineer as to what sections of the wellbore are determined to be concentric as shown by green indicia/coloration 337. The image/representation of the wellbore and data associated therewith may be configured to convey which sections of the wellbore are enlarged in part and/or non-concentric within a first predetermined threshold as shown by yellow indicia/coloration 339. The first predetermined threshold may comprise a ½ inch (˜1.3 cm) enlargement in one non-limiting embodiment. Yellow indicia/coloration 339 may convey to the operator/engineer to proceed with caution when lowering tools within the wellbore and/or performing other wellbore construction/completion operations.

Image/representation 341 of the wellbore and data associated therewith may include sections of the wellbore are enlarged in part and/or non-concentric within a second predetermined threshold as shown by red indicia/coloration 341. The second predetermined threshold may comprise a ¾ inch (˜1.9 cm) enlargement in one non-limiting embodiment. Red indicia/coloration 341 may convey to the operator/engineer a “NO GO” message and/or to not proceed with lowering tools within the wellbore and/or performing other wellbore construction/completion operations, until further action is taken to address the same for example.

Image/representations 46A of the wellbore and data associated therewith may thus be used to create rules and/or tolerances for oil and gas equipment based thereon and to dictate future engineering/construction/completion operations associated therewith that may be more tailored and/or site/wellbore specific.

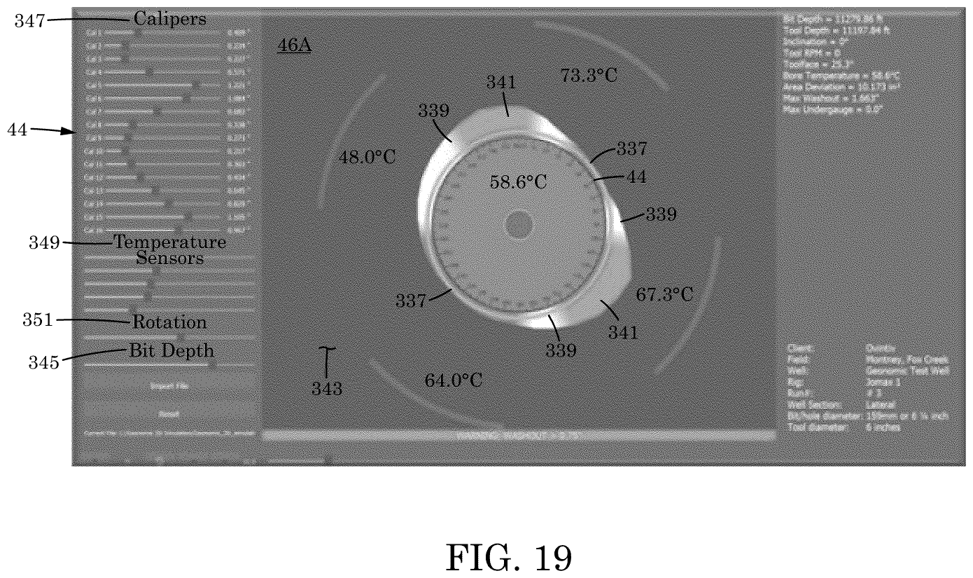

Various subsections/lateral-cross-sections of the image/representation 46A as seen in FIG. 19 may also be selectively viewed and/or analyzed as a result of the data obtained/outputted from wellbore measuring apparatus 44 as herein described. Still referring to FIG. 19, graphical user interface 343 is configured to display the wellbore measuring apparatus at a specific bit depth 345. The graphical user interface in this non-limiting example displays thereon caliper information/data/readings 347 and temperature sensor information/data/readings 349. The latter may include temperature readings displayed on the image of wellbore measuring apparatus, as well as radially spaced/adjacent regions of ground/rock: in this non-limiting embodiment the wellbore measuring apparatus has a temperature of 58.6° C. and surrounding rock quadrants have temperatures of 48° C., 64° C., 67.3° C. and 73° C. Graphical user interface 343 in this non-limiting example also displays thereon bit/wellbore-measuring-apparatus 44 rotation information/data/readings 351.

Wellbore measuring apparatus 44 as herein described may provided a number of additional advantages. The wellbore measuring apparatus so configured may enable the operator/engineer to map each open borehole/wellbore section prior to construction of a well casing or the like. Wellbore measuring apparatus 44 as herein described may promote wellbore-related regulatory compliance and/or be configured to facilitate with engineering, operations and/or construction relating to: cementing wellbores and volumes; minimum casing design and requirements; well abandonment; cementing and returns; fracking and subsurface integrity; steam-assisted gravity drainage (SAGD) subsurface integrity; wellbore integrity; licensee life-cycle management; primary wellbore cementing; wellbore remediation; wellbore decommissioning; well integrity; and/or emissions. The wellbore measuring apparatus may thus function to inhibit/reduce wellbore-related liability.

Wellbore measuring apparatus 44 may be configured to provide 3D wellbore viewing and analytics within a relatively short period of time, such as within one hour at the surface in one non-limiting example.

Wellbore measuring apparatus 44, including acoustic sensor tool 106 thereof, so configured may thus facilitate efficient serviceability thereof or components thereof. Thus, if a component of wellbore measuring apparatus 44 is damaged or in need of repair, the component in question may be replaced without requiring to repair or replace the apparatus as a whole. Acoustic sensor tool 106 is configured to mitigate the amount of stress to which the acoustic sensors 150, 152, 154 and 156, 158, 160, 162 and 164 thereof seen in FIG. 11 are subjected. The acoustic sensor tool so configured may function to promote a pressure balance for the sensors and enable sealing of pressure between internal and external flow of drilling fluid to inhibit damage to the sensor assembly or components thereof.

Wellbore measuring apparatus 44, including acoustic sensor tool 106 thereof, may be configured for tough drilling conditions and function as a delivery/transport system for the encased sensors to perform logging measurements during static wellbore conditions in one non-limiting embodiment.

Wellbore measuring apparatus 44 as herein described may be configured to be bottom-hole assembly (BHA) compatible. The wellbore measuring apparatus may function to inhibit the need for extra rig time, mobilization of crews, halting of drilling operations or trip speed limits.

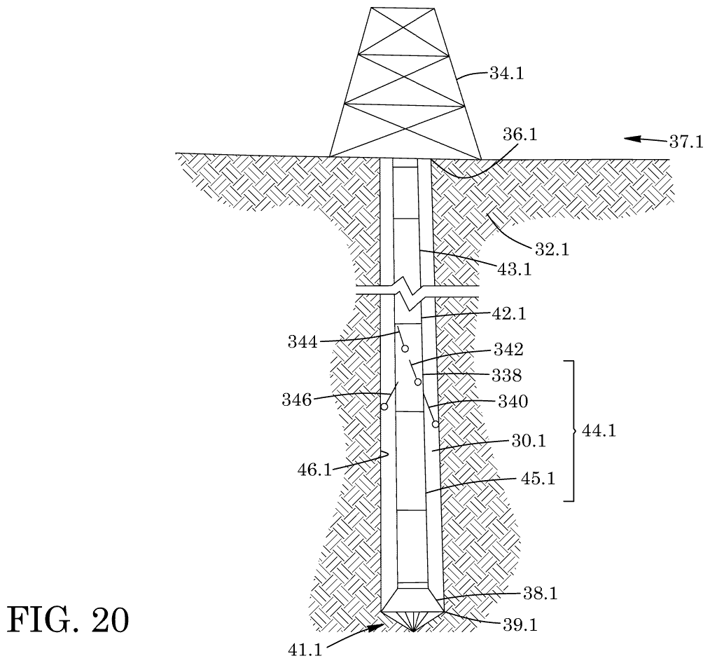

FIG. 20 shows a wellbore measuring apparatus 44.1 according to another aspect. Like parts have like numbers and functions as wellbore measuring apparatus 44 shown in FIGS. 1 to 17 with the addition of decimal extension “0.1”. Wellbore measuring apparatus 44.1 is substantially the same as wellbore measuring apparatus 44 shown in FIGS. 1 to 17 with at least the following exceptions.

Wellbore measuring apparatus 44.1 includes i) a first logging-while-tripping (LWT) unit 338 configured to log wellbore data pertaining to one or more characteristics of wellbore 30.1; and 2) a second logging-while-tripping (LWT) unit 45.1 configured to log wellbore data to one or more characteristics of a wellbore. The units may each independently obtain via sensors thereof one or more characteristics of wellbore 30.1. Wellbore measuring apparatus 44.1 may be configured to thereafter compare this data from LWT units 338 and 45.1. An indication of the accuracy of the one or more characteristics of wellbore 30.1 so determined may be obtained thereby. If the difference in the one or more characteristics of wellbore 30.1 so determined is above a predetermined threshold, the processor of wellbore measuring apparatus 44.1 may determine that calibration of one or more of the sensors is required. Second LWT unit 45.1 may couple to and be integrated with first LWT unit 338 in one non-limiting example.

In one non-limiting embodiment, each of the LWT units 338 and 44.1 configured to log wellbore data pertaining to one or more characteristics of a wellbore, may be of the type described in FIGS. 1 to 17.

In another non-limiting embodiment shown in FIG. 20, sensors of first LWT unit 338 may be configured to operate via and/or in conjunction with one or more abutting members 340, 342, 344 and 346 which selectively contact wellbore bore 46.1 of wellbore 30.1. A non-limiting example in this example is described in International Patent Application Publication No. WO 2021/0179092 to Thompson et al., the disclosure of which is hereby incorporated herein by reference. At least some of sensors, in this example those of first LWT unit 338, of wellbore measuring apparatus 30.1 may thus measure one or more characteristics of wellbore 30.1 by one or more abutting members which selectively contact the outer surface or wellbore wall 46.1 of wellbore 30.1.

In this non-limiting embodiment, sensors of second LWT unit 45.1 may be configured to operate without contacting outer surface or wellbore wall 46.1 of wellbore 30.1. These sensors of the second LWT unit may be acoustic sensors in this non-limiting embodiment and as described in more detail in FIGS. 1 to 17. At least some of the sensors of wellbore measuring apparatus 44.1, in this example those of second LWT unit 45.1, may thus measure one or more characteristics of wellbore without contacting outer surface or wellbore wall 46.1 of wellbore 30.1. One or more characteristics of the wellbore as determined via the output signals of acoustic sensors of second LWT unit 45.1 may be compared to the one or more characteristics of the wellbore as determined via the output signals of sensors which function in conjunction with abutting members 340, 342, 344 and 346.

It will be appreciated that many variations are possible within the scope of the invention described herein. Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Wellbore measuring apparatuses 44/44.1 as herein described may facilitate engineering of a wellbore a superior standard, while reducing data collection costs, such as by 90% in one non-limiting embodiment. The wellbore measuring apparatuses as herein described may be used in a variety of industries and/or for a variety of applications, including for oil and gas, geothermal, hydrogen, helium, lithium, potash, uranium, water, and carbon capture wells, for example. Wellbore measuring apparatuses 44/44.1 as herein described may enable/facilitate construction of wellbores constructed according to the physical properties of each individual wellbore section and may improve/reduce assumptions made in the process thereof.

Embodiments of the invention may be implemented using specifically designed hardware, configurable hardware, programmable processors configured by the provision of software (which may optionally comprise “firmware”) capable of executing on the processors, special purpose computers or processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable processors are: microprocessors, digital signal processors (“DSPs”), embedded processors, graphics processors, math co-processors, general purpose computers, server computers, cloud computers, mainframe computers, computer workstations, and the like. For example, one or more processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a processor, cause the processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMS, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
· “first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

The following clauses are offered as further description.
(1) A wellbore measuring apparatus comprising: an outer body that is tubular and connectable in line with a drill string; and a plurality of contactless sensors angularly spaced relative to the outer body and arranged in a plurality of tiers, each said tier comprising two or more said sensors and the tiers being spaced-apart axially from one another along the outer body, each said sensor being arranged to measure at least one characteristic of a wellbore.
(2) A wellbore measuring apparatus according to any clause herein, wherein each said sensor is an acoustic sensor.
(3) A wellbore measuring apparatus comprising: an outer body that is tubular and connectable in line with a drill string; and a plurality of acoustic sensors angularly spaced relative to the outer body and arranged in a plurality of tiers, each said tier comprising two or more said sensors and the tiers being spaced-apart axially from one another along the outer body, each said sensor being arranged to measure at least one characteristic of a wellbore.
(4) A wellbore measuring apparatus according to any clause herein, wherein each said sensor is radially inwardly spaced from an outer surface of the outer body.
(5) A wellbore measuring apparatus according to any clause herein, wherein each said sensor is radially outwardly facing in a measurement direction.
(6) A wellbore measuring apparatus according to any clause herein, wherein the sensors are positioned in a helical arrangement.
(7) A wellbore measuring apparatus according to any clause herein, wherein the sensors of each said tier are angularly spaced apart from each other by 180 degrees.
(8) A wellbore measuring apparatus according to any clause herein, wherein the wellbore measuring apparatus has an inner passageway positioned between the ends of the outer body, the inner passageway being helical in shape.
(9) A wellbore measuring apparatus comprising: an outer body that is tubular and connectable in line with a drill string; a plurality of sensors, each arranged to measure at least one characteristic of a wellbore; and an inner passageway positioned between the ends of the outer body, the inner passageway being helical in shape.
(10) A wellbore measuring apparatus according to any clause herein, wherein the plurality of sensors are angularly spaced relative to the outer body and arranged in a plurality of tiers, with each said tier comprising two or more said sensors and the tiers being spaced-apart axially from one another along the outer body.
(11) A wellbore measuring apparatus according to any clause herein, wherein the wellbore measuring apparatus has an inner passageway positioned between the ends of the outer body, the inner passageway being a double helix in shape.
(12) A wellbore measuring apparatus according to any clause herein, wherein the inner passageway is shaped to enable bypass drilling fluid to pass therethrough.
(13) A wellbore measuring apparatus comprising: an outer body that is tubular and connectable in line with a drill string; and a plurality of axially spaced pairs of sensors, with each pair of said sensors being angularly positioned relative to one or more adjacent said pairs of sensors, and each said sensor being arranged to measure at least one characteristic of a wellbore.
(14) A wellbore measuring apparatus according to any clause herein, including an internal sensor assembly to which the sensors couple and which positions the sensors into a pair of helical paths.
(15) A wellbore measuring apparatus according to any clause herein, including a housing within which the sensors are received, the housing being longitudinally twisted in shape and being configured to enable drill fluid to pass therethrough.
(16) A wellbore measuring apparatus according to any clause herein, wherein the housing and/or sensor assembly are configured to inhibit damage to the sensors.
(17) A wellbore measuring apparatus according to any clause herein, wherein each helical arrangement of sensors comprises at least four said sensors.
(18) A wellbore measuring apparatus according to any clause herein, wherein each helical arrangement of sensors comprises between four to eight said sensors.
(19) A wellbore measuring apparatus according to any clause herein, wherein the sensors are arranged to measure simultaneously the diameter(s) of the wellbore at four adjacent lateral sections thereof.
(20) A wellbore measuring apparatus according to any clause herein, wherein the sensors are arranged to measure simultaneously the diameter(s) of the wellbore at four to eight adjacent lateral sections thereof.
(21) A wellbore measuring apparatus according to any clause herein, wherein the sensors are arranged to measure simultaneously the diameter(s) of the wellbore at up to eight adjacent lateral sections thereof.
(22) A wellbore measuring apparatus according to any clause herein, wherein the sensors are positioned in a double helix arrangement.
(23) A wellbore measuring apparatus comprising: an outer body that is tubular and connectable in line with a drill string; and a plurality of sensors operatively connected to the outer body and positioned in a double helix arrangement, with each said sensor being arranged to measure at least one characteristic of a wellbore.
(24) A wellbore measuring apparatus according to any clause herein, wherein the outer body has spaced-apart ends threaded for connection with the drill string.
(25) A wellbore measuring apparatus according to any clause herein, wherein the outer body has an outer surface and a plurality of apertures extending radially inwards from the outer surface thereof, and wherein the plurality of sensors are in fluid communication with respective ones of the plurality of apertures of the outer body.
(26) A wellbore measuring apparatus according to any clause herein, wherein the apertures are arranged in one or more helical paths.
(27) A wellbore measuring apparatus according to any clause herein, wherein the plurality of apertures of the outer body are positioned in a helical arrangement.
(28) A wellbore measuring apparatus according to any clause herein, wherein the plurality of apertures of the outer body are positioned in a double helix arrangement.
(29) A wellbore measuring apparatus according to any clause herein, wherein the apertures of the outer body are circular.
(30) A wellbore measuring apparatus according to any clause herein, including a sensor assembly positioned to threadably couple to and extend within the outer body at least in part, the sensor assembly including said plurality of sensors.
(31) A wellbore measuring apparatus according to any clause herein, wherein the outer body is selectively removable from the drill string and/or the sensor assembly is selectively removable from the outer body.
(32) A wellbore measuring apparatus according to any clause herein, wherein the wellbore measuring apparatus is configured such that any one of the outer body, the sensor assembly or both the outer body and the sensor assembly, is selectively replaceable.
(33) A wellbore measuring apparatus according to any clause herein, wherein the sensor assembly includes an inner body configured to maintain a pressure balance therewithin for the sensors thereof.
(34) A wellbore measuring apparatus according to any clause herein, wherein the inner body is configured to receive the sensors therewithin in a sealed configuration to inhibit external pressures from damaging the sensors.
(35) A wellbore measuring apparatus according to any clause herein, wherein the inner body is configured to seal the sensors from drilling fluid passing internally through the wellbore measuring apparatus and passing externally about the wellbore measuring apparatus.
(36) A wellbore measuring apparatus comprising an in-line bottom hole assembly for data logging while tripping, the in-line bottom hole assembly including: an internal spiral sensor assembly that is a helical shape with two sets of sensors offset 180 degrees from each other and arranged in spirals; and an outer body coupled to and removable from the internal spiral sensor assembly.
(37) A wellbore measuring apparatus according to any clause herein, wherein the sensors include acoustic and/or piezo sensors, as well as pressure and thermal sensors.
(38) A wellbore measuring apparatus according to any clause herein, wherein the thermal sensors are positioned externally so as to facilitate detection and/or a determination of thermal variances within the wellbore.
(39) A wellbore measuring apparatus according to any clause herein, wherein the apparatus includes an internal acoustic/piezo sensor that calibrates the drilling fluid wave velocity to allow for an unmanned logging while tripping (LWT) digital wellbore system.
(40) A wellbore measuring apparatus comprising: an outer body that is tubular and connectable in line with a drill string, the outer body having a bore extending between ends thereof, the outer body having an outer surface and the outer body having a plurality of apertures extending radially inwards from the outer surface thereof, with the plurality of apertures being in fluid communication with the bore of the outer body and being positioned in a helical arrangement; and a sensor assembly positioned to threadably couple to and extend within the outer body at least in part, the sensor assembly including a plurality of sensors aligned with and positioned in communication with respective ones of said apertures of the outer body.
(41) A wellbore measuring apparatus according to any clause herein, including a plurality of sensor covers shaped to fit within respective ones of the apertures.
(42) A wellbore measuring apparatus according to any clause herein, wherein the sensor covers are configured to protect and enclose the sensors.
(43) A wellbore measuring apparatus according to any clause herein, wherein for each said sensor the sensor cover thereof is configured to inhibit access thereto and enable one or more signals thereof to pass therethrough.
(44) A wellbore measuring apparatus according to any clause herein, wherein each said sensor cover comprises a window.
(45) A wellbore measuring apparatus comprising: an outer body that is tubular and connectable in line with a drill string, the outer body having a plurality of apertures extending radially inwards therein; a plurality of sensors, each aligning with a corresponding said aperture, with each said sensor being arranged to measure at least one characteristic of a wellbore; and a plurality of windows, each covering a respective said aperture.
(46) A wellbore measuring apparatus according to any clause herein, wherein the windows are configured to facilitate visual inspection of the sensors therewithin.
(47) A wellbore measuring apparatus according to any clause herein, wherein the sensors are encased.
(48) A wellbore measuring apparatus comprising: an outer body that is tubular and connectable in line with a drill string, the outer body having a plurality of apertures extending radially inwards therein; and a plurality of sensors, each aligning with a corresponding said aperture, with each said sensor being arranged to measure at least one characteristic of a wellbore and with each said sensor being encased.
(49) A wellbore measuring apparatus according to any clause herein, including at least one elongate member coupled to and extending radially outwards from the outer surface of the outer body, with the at least one elongate member being helical in shape.
(50) A wellbore measuring apparatus according to any clause herein, wherein the at least one elongate member is configured to inhibit the sensors from being damaged from the wellbore.
(51) A wellbore measuring apparatus according to any clause herein, including electronics and wherein the at least one elongate member is configured to stabilize the wellbore measuring apparatus in the wellbore to inhibit shock and vibration damage to the electronics during drilling operations.
(52) A wellbore measuring apparatus according to any clause herein, wherein the sensors align with and extend adjacent to the at least one elongate member.
(53) A wellbore measuring apparatus according to any clause herein, wherein the sensors align adjacent to and extend along one side of the at least one elongate member.
(54) A wellbore measuring apparatus comprising: an outer body that is tubular and connectable in line with a drill string; and at least one helical elongate member coupled to and extending radially outwards from the outer body; and a plurality of sensors extending adjacent and radially inwardly positioned relative to said at least one helical elongate member, with each said sensor being arranged to measure at least one characteristic of a wellbore.
(55) A wellbore measuring apparatus comprising: an outer body that is tubular and connectable in line with a drill string; and two or more angularly spaced-apart helical elongate members coupled to and extending radially outwards from the outer body; and a plurality of sensors positioned between and extending along said helical elongate members, with each said sensor being arranged to measure at least one characteristic of a wellbore.
(56) A wellbore measuring apparatus according to any clause herein, wherein each said elongate member is configured to be removable.
(57) A wellbore measuring apparatus according to any clause herein, wherein each said elongate member is configured to be redressable.
(58) A wellbore measuring apparatus according to any clause herein, including double helix tapered said elongate members contoured to the spiral of apertures on the outer body and which centralize the apparatus in the wellbore while protecting the apertures from filling with debris.
(59) A wellbore measuring apparatus according to any clause herein, wherein each said elongate member is a rib.
(60) A wellbore measuring apparatus according to any clause herein, wherein each said elongate member is a blade.
(61) A wellbore measuring apparatus according to any clause herein, wherein each said elongate member is a tapered blade.
(62) A wellbore measuring apparatus according to any clause herein, wherein each said elongate member is a curved in outer profile.
(63) A wellbore measuring apparatus according to any clause herein, wherein the wellbore measuring apparatus is configured for logging while tripping (LWT).
(64) A wellbore measuring apparatus according to any clause herein, wherein the wellbore measuring apparatus is configured for logging while drilling (LWD).
(65) A wellbore measuring apparatus according to any clause herein, wherein the wellbore measuring apparatus is configured for measurement while drilling (MWD).
(66) A wellbore measuring apparatus according to any clause herein, wherein the sensors are configured to collect data pertaining to one or more characteristics of the wellbore while the drill string is being removed from the wellbore.
(67) A wellbore measuring apparatus according to any clause herein, wherein the sensors are configured to collect data pertaining to one or more characteristics of the wellbore while the drill string is being inserted into the wellbore.
(68) A wellbore measuring apparatus according to any clause herein, wherein the wellbore measuring apparatus is configured to gather wellbore data while tripping in the wellbore back to the bottom of the wellbore and/or tripping out of the wellbore back to the surface.
(69) A wellbore measuring apparatus according to any clause herein, wherein the wellbore measuring apparatus is configured to gather wellbore data in the process of removing piping from the wellbore and/or replacing piping from the drill string.
(70) A wellbore measuring apparatus according to any clause herein, including a processor configured to receive output signals from the sensors and to log the output signals.
(71) A wellbore measuring apparatus according to any clause herein, wherein including firmware to process via the processor the output signals from the sensors to determine said at least one characteristic of the wellbore.
(72) A wellbore measuring apparatus according to any clause herein, wherein the firmware is configured to process via the processor the output signals from the sensors to determine a profile of the wellbore.
(73) A wellbore measuring apparatus according to any clause herein, wherein the wellbore measuring apparatus is configured to log wellbore data during static wellbore conditions.
(74) A wellbore measuring apparatus according to any clause herein, wherein the wellbore measuring apparatus is configured to log wellbore data related to physical conditions of the wellbore, including one or more of internal dimeter readings and/or temperature readings of the open hole wellbore.
(75) A wellbore measuring apparatus according to any clause herein, wherein the sensors are positioned to obtain a full geometry of the borehole by collecting all or substantially all equally spaced radial data measuring points thereof.
(76) A wellbore measuring apparatus according to any clause herein, wherein the sensors are arranged to generate via the processor a three-dimensional (3D) model of the wellbore.
(77) A wellbore measuring apparatus according to any clause herein, wherein the sensors are arranged to generate via the processor an integrated three-dimensional (3D) mesh model of the wellbore.
(78) A wellbore measuring apparatus according to any clause herein, wherein the three-dimensional (3D) mesh and/or model of the wellbore is configured to facilitate subsequent wellbore construction and/or completion operations.
(79) A wellbore measuring apparatus according to any clause herein, wherein the 3D mesh and/or model of the wellbore includes a first indicia/coloration thereof which indicates a region of the wellbore which is substantially concentric and a second indicia/coloration which indicates a region of the wellbore which exceeds in part and/or which is non-concentric within a predetermined threshold.
(80) A wellbore measuring apparatus according to any clause herein, wherein the second indicia/coloration is configured to convey a message of proceeding with caution.
(81) A wellbore measuring apparatus according to any clause herein, wherein the second indicia/coloration indicates that the region of the wellbore is enlarged at least in part.
(82) A wellbore measuring apparatus according to any clause herein, including a third indicia/coloration which indicates a region of the wellbore which exceeds in part and/or which is non-concentric within a second predetermined threshold.
(83) A wellbore measuring apparatus according to any clause herein, wherein the third indicia/coloration is configured to convey a NO GO message and/or a message that further and/or corrective action is required.
(84) A wellbore measuring apparatus according to any clause herein, wherein the wellbore measuring apparatus includes a helical or spiral shape configured to offset the sensors radially in order to promote obtain a full geometry of the wellbore by collecting all or substantially all equally spaced radial data measuring points so as to obtain an integrated three-dimensional (3D) mesh model.
(85) A wellbore measuring apparatus according to any clause herein, wherein the sensors are arranged to facilitate generation of a three-dimensional (3D) model of a wellbore having an irregular shape.
(86) A wellbore measuring apparatus according to any clause herein, wherein the sensors are positioned in a helical arrangement which enables extra sensor density to fill in the data for a wellbore having an irregular shape.
(87) A wellbore measuring apparatus according to any clause herein, wherein the sensors are configured to obtain an even number of radial measurements, with each pair of said radial measurements being 180 degrees apart to obtain diameters that create wellbore inner dimension readings which are translated into a three-dimensional (3D) wellbore mesh.
(88) A wellbore measuring apparatus according to any clause herein, wherein the firmware is configured to obtain via the processor a three-dimensional (3D) well bore mesh point and generate a point cloud system based the output signals.
(89) A wellbore measuring apparatus according to any clause herein, wherein the firmware and/or advanced three-dimensional (3D) math is configured/used to determine via the processor one or more actual borehole volumes based the output signals.
(90) A wellbore measuring apparatus according to any clause herein, wherein the firmware is configured to determine via the processor where to place equipment in the wellbore based on the output signals.
(91) A wellbore measuring apparatus according to any clause herein, wherein the firmware is configured to apply well construction math via the processor to particular wellbore equipment and associated wellbore diameter tolerances so determined based on the output signals, so as to inhibit geomechanical activity responsible for damaging downhole completion equipment including well casing thereby.
(92) A wellbore measuring apparatus according to any clause herein, wherein the wellbore measuring apparatus is configured to enable an operator to log wellbore data while the drill string is moved towards the bottom of the wellbore to determine time dependent changes in the wellbore on each bit run, and determine volumes of drilling fluid seeped into the formation while a standing mud column remained in the borehole.
(93) A wellbore measuring apparatus according to any clause herein, wherein the wellbore measuring apparatus is configured to enable a workover rig to log a well casing on the bottom hole assembly or wireline unit on the way down to the bottom of the wellbore in order to avoid multiple trips in and out of the wellbore.
(94) A wellbore measuring apparatus according to any clause herein, wherein the wellbore measuring apparatus is configured to inhibit damage to the casing and thus further remediation of the wellbore.
(95) A wellbore measuring apparatus according to any clause herein, wherein the processor is configured to create a pre-determined wave function to match the receiving signal of one or more said sensors for a more defined reading.
(96) A wellbore measuring apparatus according to any clause herein, wherein the wellbore measuring apparatus is configured to obtain the impedance of the drilling fluid while downhole with a fluid chamber and fixed distance with a piezo sensor for a full unmanned system, with a drill fluid reading at the surface functioning as back up standard information if the fluid reservoir is plugged off with sediment and wherein another calibration unit comprises a surface station containing a substantially similar piezo sensor as that of the wellbore measuring apparatus and which is fillable with mud from the outflow at a shaker to provide accurate drilling fluid sound wave velocity.
(97) A wellbore measuring apparatus according to any clause herein, including a protective cap with a substantially similar impedance ratio to the fluid in the sensor assembly unit to match acoustic impedance so as to inhibit attenuation and reflection of the signal.
(98) A wellbore measuring apparatus according to any clause herein, including a material used as a protective layer that also matches the impedance of the sensing assembly.
(99) A wellbore measuring apparatus according to any clause herein, wherein said material comprise ultra-high-molecular-weight polyethylene (UHMWPE) spectra fibre.
(100) A wellbore measuring apparatus according to any clause herein, wherein the wellbore measuring apparatus is configured to be robust and is configured to function as a delivery system for the sensors to perform logging measurements during static wellbore conditions.
(101) A wellbore measuring apparatus comprising a logging-while-tripping (LWT) bottom hole assembly which remains part of a drilling assembly and is only activated to log a wellbore during static (non-drilling) conditions and procedures.
(102) A wellbore measuring apparatus comprising a logging-while-tripping (LWT) bottom hole assembly with i) an outer body connectable in line with a drill string and having a passageway extending through the outer body between the ends thereof, ii) a plurality of sensors arranged to measure at least one characteristic of a wellbore and iii) a processor configured to receive output signals from the sensors, the processor being configured to log the output signals during static or non-drilling conditions.
(103) A wellbore measuring apparatus according to any clause herein, comprising a logging-while-tripping (LWT) unit configured to operate in line with a drill string, with the LWT unit being configured to include multi sensing capabilities and with the LWT unit memory logging data while tripping out.
(104) A wellbore measuring apparatus according to any clause herein, including measurement while drilling (MWD) components and/or a MWD unit comprising a variety of sensors which allow for continued drilling operation while collecting data with the sensors relating to the progress of the drilling operation.
(105) A wellbore measuring apparatus comprising: a first logging-while-tripping (LWT) unit configured to log wellbore data to one or more characteristics of a wellbore; and
measurement while drilling (MWD) components and/or a MWD unit comprising a variety of sensors which allow for continued drilling operation while collecting data with the sensors relating to the progress of the drilling operation.
(106) A wellbore measuring apparatus comprising: a first logging-while-tripping (LWT) unit configured to log wellbore data to one or more characteristics of a wellbore; and a second logging-while-tripping (LWT) unit configured to log wellbore data to said one or more characteristics of a wellbore, the first LWT unit coupling to and being integrated with the second LWT unit.
(107) A wellbore measuring apparatus according to any clause herein, wherein at least some of the sensors measure one or more characteristics of the wellbore without contacting the outer surface of the wellbore and wherein at least some of the sensors measure one or more characteristics of the wellbore by one or more abutting members which selectively contact the outer surface of the wellbore.
(108) A wellbore measuring apparatus according to any clause herein, wherein at least some of the sensors are acoustic sensors and wherein at least some of the sensors function in conjunction with abutting members which selectively abut the outer surface of the wellbore.
(109) A wellbore measuring apparatus according to any clause herein, wherein the first LWT unit includes acoustic, piezo, thermal and pressure sensors, and wherein the second LWT unit is a multi-arm system operated in conjunction with the first LWT unit to perform corrections and/or calibrations of either of the LWT units on the same drill string.
(110) A wellbore measuring apparatus according to any clause herein, wherein the wellbore measuring apparatus is configured to enable calibration of wave velocity while down hole on drilling fluid, due to a position of a sensor with a pseudo echo chamber.
(111) A wellbore measuring apparatus according to any clause herein, wherein the one or more characteristics of the wellbore as determined via the output signals of the acoustic sensors are compared via a processor to the one or more characteristics of the wellbore as determined via the output signals of the sensors which function in conjunction with abutting members, and an indication of the accuracy of the one or more characteristics of the wellbore so determined is obtained thereby.
(112) A wellbore measuring apparatus according to any clause herein, wherein the one or more characteristics of the wellbore as determined via the output signals of the acoustic sensors are compared via a processor to the one or more characteristics of the wellbore as determined via the output signals of the sensors which function in conjunction with abutting members, and if the difference in the one or more characteristics of the wellbore so determined is above a predetermined threshold, the processor determines that calibration of one or more of the sensors is required.
(113) A wellbore measuring apparatus according to any clause herein, wherein the wellbore measuring apparatus is configured with telemetry and/or comprises a telemetry transmitter to facilitate data transfer to the surface for real time applications on work over well operations.
(114) A wellbore measuring apparatus according to any clause herein, including a memory-based logging unit which transfers data wirelessly to the surface for full wireless data transfer.
(115) A wellbore measuring apparatus according to any clause herein, wherein the wireless measuring apparatus is configured to wirelessly download the data so obtain/stored from the firmware using a system that is searching for the firmware, wherein when the system is in range, the data is downloaded automatically and wherein the memory banks of the firmware are deleted thereafter.
(116) A wellbore measuring apparatus according to any clause herein, wherein the wellbore measuring apparatus is configured to promote wellbore-related regulatory compliance.
(117) A wellbore measuring apparatus according to any clause herein, wherein the wellbore measuring apparatus is configured to facilitate engineering, operations and/or construction relating to: cementing wellbores and volumes; minimum casing design and requirements; well abandonment; cementing and returns; fracking and subsurface integrity; steam-assisted gravity drainage (SAGD) subsurface integrity; wellbore integrity; licensee life-cycle management; primary wellbore cementing; wellbore remediation; wellbore decommissioning; well integrity; and/or emissions.
(118) A method of determining a profile and/or at least one characteristic of a wellbore, the method comprising: logging-while-tripping via a first logging-while-tripping (LWT) unit configured to log wellbore data to one or more characteristics of the wellbore; logging-while-tripping via a second logging-while-tripping (LWT) unit configured to log wellbore data to said one or more characteristics of the wellbore; and determining the profile of the wellbore taking into account data of outputted from both the first LWT unit and the second LWT unit.
(119) A method according to any clause herein, including coupling to the first LWT unit with the second LWT unit.
(120) A method according to any clause herein, including: comparing the profile of the wellbore as determined by the first LWT unit with the profile of the wellbore as determined by the second LWT unit.
(121) A method according to any clause herein, including: providing the first LWT unit with a plurality of contactless sensors which measure one or more characteristics of the wellbore without contacting the outer surface of the wellbore; and providing the second LWT unit with a plurality of sensors to measure one or more characteristics of the wellbore via one or more abutting members which selectively contact the outer surface of the wellbore.
(122) A method according to any clause herein, including: providing each said LWT unit with a plurality of longitudinally spaced sensors positioned in one or more helical arrangements.
(123) A method according to any clause herein, wherein the first LWT unit includes acoustic, piezo, thermal and pressure sensors, and wherein the second LWT unit is a multi-arm system operated in conjunction with the first LWT unit to perform corrections and/or calibrations of either of the LWT units on the same drill string.
(124) A method according to any clause herein, including: performing corrections and/or calibrations of either of the LWT units on the same drill string based on outputs thereof.
(125) A method according to any clause herein, including: comparing the outputs of the LWT units and determining that the profile of the wellbore is accurate and/or substantially correct if the profile of the wellbore as determined via each said LWT unit is substantially equal within a predetermined threshold.
(126) A method according to any clause herein, including: comparing the outputs of the LWT units and determining that at least one of the LWT units requires correction and/or re-calibration if the if the difference in the profiles of the wellbore as determined via each said LWT unit exceeds a predetermined threshold.
(127) A method of measuring at least one characteristic of a wellbore, the method comprising: removably coupling a tubular body in line with a drill string; positioning a plurality of longitudinally-spaced contactless sensors in a helical pattern relative to the outer body and arranged in a plurality of tiers, with each said tier comprising two or more said sensors and the tiers being spaced-apart axially from one another along the outer body; and measuring the at least one characteristic of the wellbore via the sensors.
(128) A method according to any clause herein, including threadably coupling the tubular body to the drill string.
(129) A method according to any clause herein, including providing the tubular body with acoustic said sensors.
(130) A method according to any clause herein, including positioning the sensors radially inwards from an outer surface of the outer body.
(131) A method according to any clause herein, including providing an inner passageway positioned between spaced-apart ends of the outer body, the inner passageway being helical in shape.
(132) A method according to any clause herein, including providing an inner passageway positioned between spaced-apart ends of the outer body, the inner passageway being a double helix in shape.
(133) A method according to any clause herein, including configuring the outer body, and/or providing a housing and/or sensor assembly configured to, inhibit damage to the sensors.
(134) A method according to any clause herein, including positioning the sensors in a double helix arrangement.
(135) A method of measuring at least one characteristic of a wellbore, the method comprising: removably coupling a tubular body in line with a drill string; forming a plurality of longitudinally-spaced and helically-arranged apertures into an outer surface of the tubular body; positioning a plurality of sensors in fluid communication with respective ones of the apertures; and measuring the at least one characteristic of the wellbore via the sensors.
(136) A method according to any clause herein, including forming each aperture to be circular in outer profile.
(137) A method according to any clause herein, including configuring the outer body and sensors thereof to be selectively removable from the drill string and/or replaceable.
(138) A method according to any clause herein, including encasing each said sensor.
(139) A method according to any clause herein, including configuring the sensors to be visible via respective windows or sensor coverings.
(140) A method according to any clause herein, including inhibiting damages to the sensors via one or more elongate members coupled to and extending radially outwards from the outer body.
(141) A method according to any clause herein, including forming the one or more elongate members to be helical in shape.
(142) A method according to any clause herein, including forming the one or more elongate members to be removable and/or redressable.
(143) A method according to any clause herein, including forming the one or more elongate members to extend adjacent the path of the sensors.
(144) A method according to any clause herein, including forming the one or more elongate members to comprise ribs or blades.
(145) A method according to any clause herein, including forming the one or more elongate members to have tapered ends.
(146) A method according to any clause herein, including: storing said data obtained from the sensors locally within a wellbore measuring apparatus; and transmitting said data to a remote server for further processing when within range thereof.
(147) A method according to any clause herein, including: obtaining serial data via the sensors; storing said serial data locally; wireless transmitting said serial data to a remote server when within range thereof; thereafter deleting the serial data so transmitted; next converting the serial data to a tabular data file format; next uploading the data so converted to a cloud-based web application; next performing a data step matching process where directional drilling survey data is step extrapolated out to match exact data step as caliper and thermal data; and next converting said data so step extrapolated to a high number of radii measurements of the wellbore for added mesh points.
(148) A method according to any clause herein, including using said data so step extrapolated for three-dimensional (3D) wellbore visualization.
(149) A method according to any clause herein, including using said data so step extrapolated for machine learning and/or artificial intelligence analysis.
(150) A method of measuring at least one characteristic of a wellbore, the method comprising: removably coupling a tubular body in line with a drill string; forming a plurality of longitudinally-spaced and helically-arranged apertures into an outer surface of the tubular body; positioning a plurality of sensors in fluid communication with respective ones of the apertures; and measuring radii, pressure and thermal properties of the wellbore via the sensors while tripping out of the wellbore to the surface.
(151) A method according to any clause herein, including obtaining data from said measuring step.
(152) A method according to any clause herein, including data logging said radii, pressure and thermal measurements of the wellbore via the sensors. A
(153) A method according to any clause herein, including logging said radii, pressure and thermal measurements of the wellbore via the sensors as serial data while tripping out of the wellbore to the surface.
(154) A method according to any clause herein, including compact memory logging radii, pressure and thermal measurements of the wellbore via the sensors as serial data while tripping out of the wellbore to the surface.
(155) A method according to any clause herein, including wirelessly downloading the serial data to a remote server when in range thereof once at or near the surface.
(156) A method according to any clause herein, including decoding the serial data so downloaded via a surface decoder in conjunction with software that generates tabular data files containing the correct depths to time measurements;
(157) A method according to any clause herein, including step matching directional drilling survey data so as to obtain coherent data models with which to work from inside a database.
(158) A method according to any clause herein, including extrapolating out caliper data into a higher number of radii of the wellbore in a web portal and/or remote server, thereby adding further mesh points for three-dimensional (3D) rendering and manipulation.
(159) A method according to any clause herein, including contrasting the extrapolated out data against thermal and pressure data and electronic drilling recorder data via one or more analytics algorithms.
(160) A method according to any clause herein, including, upon thermal, pressure, caliper and image file data being uploaded into a web-portal and/or cloud-environment, splitting the data into one or more databases to facilitate two-dimensional (2D) and three-dimensional (3D) visualizations.
(161) A method according to any clause herein, including, upon thermal, pressure, caliper and image file data being uploaded into a web-portal and/or cloud-environment, splitting the data into one or more databases to drive desired output results/information depending on input parameters, including wellbore construction and/or cementing applications information.
(162) A method according to any clause herein, including mapping each open borehole/wellbore section using said data prior to construction of a well casing or the like.
(163) A method according to any clause herein, including using said data to inhibit/reduce wellbore-related liability.
(164) A method according to any clause herein, including using said data to promote and/or facilitate wellbore-related regulator compliance.
(165) A method according to any clause herein, including using said data to facilitate engineering, operations and/or construction relating to: cementing wellbores and volumes; minimum casing design and requirements; well abandonment; cementing and returns; fracking and subsurface integrity; steam-assisted gravity drainage (SAGD) subsurface integrity; wellbore integrity; licensee life-cycle management; primary wellbore cementing; wellbore remediation; wellbore decommissioning; well integrity; and/or emissions.
(166) Apparatus including any new and inventive feature, combination of features, or sub-combination of features as described herein.
(167) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A wellbore measuring apparatus comprising:
an outer body that is tubular and connectable in line with a drill string; and
a plurality of sensors operatively connected to the outer body and positioned in a double helix arrangement, with each said sensor being arranged to measure at least one characteristic of a wellbore.

2. A wellbore measuring apparatus according to claim 1, wherein the plurality of sensors are angularly spaced relative to the outer body and arranged in a plurality of tiers, with each said tier comprising two or more said sensors and the tiers being spaced-apart axially from one another along the outer body.

3. A wellbore measuring apparatus according to claim 2, wherein each said tier comprises at least four said sensors and/or between four to eight said sensors.

4. A wellbore measuring apparatus comprising:
an outer body that is tubular and connectable in line with a drill string;
a plurality of sensors operatively connected to the outer body, each said sensor being arranged to measure at least one characteristic of a wellbore; and
an inner passageway positioned between spaced-apart ends of the outer body, the inner passageway being helical in shape.

5. A wellbore measuring apparatus according to claim 4, wherein the inner passageway is a double helix in shape.

6. A wellbore measuring apparatus comprising:
an outer body that is tubular and connectable in line with a drill string;
a plurality of sensors operatively connected to the outer body, each said sensor being arranged to measure at least one characteristic of a wellbore; and
a housing within which the sensors are received, the housing being longitudinally twisted in shape and enabling drill fluid to pass therethrough.

7. A wellbore measuring apparatus according to claim 6, wherein the housing is positioned within the outer body and shaped to inhibit damage to the sensors.

8. A wellbore measuring apparatus according to claim 6, wherein the outer body has an outer surface and a plurality of apertures extending radially inwards from the outer surface thereof, wherein the apertures are circular, and wherein the plurality of sensors align with respective ones of the plurality of apertures of the outer body.

9. A wellbore measuring apparatus according to claim 8, including a plurality of sensor covers shaped to fit within respective ones of the apertures, wherein: the sensor covers are shaped to protect and enclose the sensors; for each said sensor the sensor cover thereof is shaped to inhibit access thereto and enable one or more signals thereof to pass therethrough; and/or the sensor covers comprise windows which facilitate visual inspection of the sensors therewithin.

10. A wellbore measuring apparatus according to claim 6, including an internal sensor assembly to which the sensors couple, wherein: the internal sensor assembly positions the sensors into a pair of helical paths; the internal sensor assembly has a helical shape with two sets of said sensors offset 180 degrees from each other and arranged in spirals; the outer body couples to and is removable from the internal sensor assembly; the internal sensor assembly is positioned to threadably couple to and extend within the outer body at least in part; and/or the outer body is selectively removable from the drill string and the sensor assembly is selectively removable from the outer body.

11. A wellbore measuring apparatus according to claim 6, wherein the sensors comprise: contactless sensors; acoustic/piezo sensors; pressure sensors; thermal sensors positioned externally so as to facilitate detection and/or a determination of thermal variances within the wellbore; and/or an internal acoustic/piezo sensor that calibrates drilling fluid wave velocity to allow for an unmanned logging while tripping (LWT) digital wellbore system.

12. A wellbore measuring apparatus according to claim 6, wherein the wellbore measuring apparatus is configured for: logging while tripping (LWT); logging while drilling (LWD); and/or measurement while drilling (MWD).

13. A wellbore measuring apparatus according to claim 6, wherein the sensors are arranged to generate via a processor and/or software, a three-dimensional (3D) model and/or an integrated 3D mesh model of the wellbore, and wherein the 3D model and/or 3D mesh model of the wellbore facilitates subsequent wellbore construction and/or completion operations.

14. A wellbore measuring apparatus according to claim 13, wherein the 3D model and/or 3D mesh model of the wellbore includes a first indicia/coloration thereof which indicates a region of the wellbore which is substantially concentric, wherein the 3D model and/or 3D mesh model of the wellbore includes a second indicia/coloration, and wherein: the second indicia/coloration indicates a region of the wellbore which exceeds in part and/or which is non-concentric within a predetermined threshold; the second indicia/coloration conveys a message of proceeding with caution; and/or the second indicia/coloration indicates that the region of the wellbore is enlarged at least in part.

15. A wellbore measuring apparatus according to claim 14, wherein the 3D model and/or 3D mesh model of the wellbore includes a third indicia/coloration, and wherein: the third indicia/coloration indicates a region of the wellbore which exceeds in part and/or which is non-concentric within a second predetermined threshold; and/or the third indicia/coloration conveys a NO GO message and/or a message that further and/or corrective action is required.

16. A wellbore measuring apparatus according to claim 6, including a processor which receives output signals from the sensors, and including firmware configured to obtain via the processor a three-dimensional (3D) well bore mesh point and generate a point cloud system based the output signals.

17. A wellbore measuring apparatus according to claim 16, wherein the firmware and/or advanced 3D math determines via the processor: actual borehole volume(s) based the output signals; and/or where to place equipment in the wellbore based on the output signals.

18. A wellbore measuring apparatus according to claim 16, wherein the firmware applies well construction math via the processor to particular wellbore equipment and associated wellbore diameter tolerances so determined based on the output signals, so as to inhibit geomechanical activity responsible for damaging downhole completion equipment including well casing thereby.

19. A wellbore measuring apparatus according to claim 16, wherein the processor is configured to create a pre-determined wave function to match the receiving signal of one or more said sensors for a more defined reading.

20. A wellbore measuring apparatus according to claim 6, wherein the wellbore measuring apparatus enables an operator to log wellbore data while the drill string is moved towards a bottom of the wellbore to determine time dependent changes in the wellbore on each bit run, and determines volumes of drilling fluid seeped into a formation while a standing mud column remains in the wellbore.
